(19) United States
(12) Patent Application Publication
(10) Pub. No.: US 2026/0227647 A1
(43) Pub. Date: Aug. 6, 2026

(54) TILTED AND/OR EXTRUDED OPTICAL ELEMENTS FOR THE MANAGEMENT OF MYOPIA

(71) Applicants: NTHALMIC HOLDING PTY LTD, Sydney, New South Wales (AU); SHANGHAI ISPARX MEDICAL CO., LTD, SHANGHAI (CN)

(72) Inventors: Klaus EHRMANN, Sydney, New South Wales (AU); Cathleen FEDTKE, Sydney, New South Wales (AU); Darrin FALK, Sydney, New South Wales (AU); Karen LAHAV-YACOUEL, Sydney, New South Wales (AU); Ravi Chandra BAKARAJU, Sydney, New South Wales (AU)

(73) Assignees: Nithalmic Holding Pty Ltd, Sydney, New South Wales (AU); SHANGHAI ISPARX MEDICAL CO., LTD, SHANGHAI (CN)

(21) Appl. No.: 19/152,451

(22) PCT Filed: Feb. 2, 2024
(86) PCT No.: PCT/AU2024/050063

§ 371 Date: Jul. 31, 2025

(30) Foreign Application Priority Data
Feb. 3, 2023 (AU) 2023900258

(51) Int. Cl. G02C 7/02

(52) U.S. Cl. CPC G02C 7/022; G02C 7/027; G02C 7/028; G02C 2202/24

(57) ABSTRACT

The present disclosure relates to means of managing eye-length related disorders, like myopia. The invention includes a spectacle lens for myopia management, wherein the spectacle lens is configured with an optical zone comprising a central distance zone and at least one peripheral treatment zone configured with optical elements to increase the light intensity of the through-focus retinal image spread. The central distance zone of the spectacle lens provides foveal correction and the optical elements within the at least one peripheral treatment zone provide directional cues to the peripheral retina of the myopic eye, serving as an optical stop signal to decelerate, control, inhibit, or reduce the rate of myopia progression.

### CROSS-REFERENCE

The present disclosure is related to WO 2021/159170 entitled “Spectacle lenses with auxiliary optical elements” which is herein incorporated by reference in its entirety.

### FIELD OF THE INVENTION

The present disclosure relates to spectacle lenses for use with eyes experiencing eye-length related disorders, like myopia.

### BACKGROUND

The growth of the human eye is controlled by a feedback mechanism and regulated predominantly by the visual experience of the world referred to as emmetropisation. The signals that guide the emmetropisation process are initiated by the modulation of light energy received at the retina. The image characteristics are monitored by a biological process that modulates the signal to start, stop, accelerate, or slow the rate of eye growth. Derailing from the emmetropisation process potentially results in refractive disorders like myopia. Myopia is an optical disorder of the eye, wherein the images of distant objects are focused in front of the fovea or retina. The rate of incidence of myopia is increasing at alarming rates in many regions of the world, particularly in the East Asia region. Although a pair of negative lenses can optically correct myopia, they do not address the underlying cause of the excessive eye growth, which often leads to high myopia, which is further associated with significant vision-threatening conditions like cataract, glaucoma, myopic maculopathy, and retinal detachment. Thus, there remains a need for specific optical treatments for such individuals, that not only correct the underlying error but also prevent excessive eye lengthening.

### Definitions

Terms used herein are generally used by a person skilled in the art unless otherwise defined in the following:

The term “myopic eye” or “myopic eye without astigmatism” means an eye that is either already experiencing myopia, is in the stage of pre-myopia, is at risk of becoming myopic, or is diagnosed to have a refractive condition that is progressing towards myopia and has astigmatism of less than 1 DC.

The term “myopic astigmatic eye” or “myopic eye with astigmatism” means an eye that is either already experiencing myopia, is in the stage of pre-myopia, is at risk of becoming myopic, or is diagnosed to have a refractive condition that is progressing towards myopia and has astigmatism of equal to or more than 1 DC.

The term “progressing myopic eye” means an eye with established myopia that is diagnosed to be progressing, as gauged by either the change in refractive error of at least −0.25 D/year or the change in axial length of at least 0.1 mm/year.

The term “pre myopic” or “an eye at risk of becoming myopic” means an eye, which could be emmetropic or is low hyperopic at the time but has been identified to have an increased risk of becoming myopic based on genetic factors (e.g., both parents are myopic) and/or age (e.g., being low hyperopic at a young age) and/or environmental factors (e.g., time spent outdoors) and/or behavioural factors (e.g., time spent performing near tasks).

The term “optical stop signal” or “stop signal” or “directional cue” means an optical signal that may facilitate slowing, reversing, arresting, retarding, inhibiting, or controlling the growth of an eye and/or refractive condition of the eye.

The term “through-focus” means a region that is substantially anterior-posterior to the retina. In other words, a region approximately just in front of the retina and/or approximately just behind the retina.

The term “optical element” means the region on the spectacle lens in the peripheral treatment zone that has the prescribed optical effect that is different from the optical effect provided by the base prescription of the spectacle lens.

The term “spectacle lens” may mean a finished or semi-finished spectacle lens blank. The term “standard single vision spectacle lens” or “commercially available single vision spectacles”, “standard spectacles”, “base prescription for correcting the refractive error”, “distance prescription” or “integral base spectacle lens” means spectacle lenses used to correct the underlying refractive error of the eye; wherein the refractive error may be myopia, with or without astigmatism.

The term “optical zone” or “optic zone” means the region on the spectacle lens which has the prescribed optical effect.

The term “myopia management spectacle lens” means a spectacle lens with a central zone and at least one peripheral treatment zone, wherein the central zone is configured with a distance prescription to provide foveal correction for the myopic eye; wherein the at least one peripheral treatment zone is configured with a plurality of tilted optical elements or extruded optical elements with or without tilt surrounded by distance prescription.

The term or phrase “central distance zone” or “central zone” means the central zone of the optic zone that has substantially a spherical or toric power distribution to correct the distance refractive error of the eye.

The term or phrase “peripheral treatment zone” means a peripheral zone of the optic zone that is configured with optical elements that provide an optical stop signal, wherein the optical elements are surrounded by areas with substantially spherical or toric power distribution to correct the distance refractive error of the eye.

The term or phrase “axicon” means an optical element that has a shape like a cone wherein the apex of the cone is perpendicular to the geometric centre of the base of the cone.

The term or phrase “tilted axicon” means an optical element that is an axicon or a cone wherein the apex of the axicon is not perpendicular to the geometric centre of the base of the axicon.

The term or phrase “lensacon” means an optical element that has a shape like a cone with a curved apex or a curved lens top, wherein the apex of the cone with the curved apex is perpendicular to the geometric centre of the base of the cone.

The term or phrase “tilted lensacon” means an optical element that is a lensacon or a cone with a curved apex or a curved lens top, wherein the apex of the lensacon is not perpendicular to the geometric centre of the base of the lensacon.

The term or phrase “extruded optical element” means an optical element comprising of two outer semi-elements and one connecting element.

The terms or phrases “extruded optical element without tilt” or “extruded optical element with centred axis” means an extruded optical element, wherein the apex or apex line of the connecting element, i.e., the axis connecting the apices of the two outer semi-elements, is centred with respect to the primary line bisecting the rectangular base of the connecting element.

The terms or phrases “tilted extruded optical element” or “extruded optical element with tilt” means an optical element comprising of two outer semi-elements and one connecting element. The apex or apex line of the connecting element, i.e., the axis connecting the apices of the two outer semi-elements, is decentred with respect to the primary line bisecting the rectangular base of the connecting element.

The term “radial” in the context of describing the outer semi-elements of extruded optical elements means in the direction radiating out to the outer margin of the outer semi-elements, defined along an azimuthal angle. The phrase “radial spoke” means a spoke radiating outward within the described outer semi-elements, at a predetermined azimuthal angle.

The terms “azimuth or azimuthal angles” mean in the direction along the circumference of the two combined outer semi-elements, defined at an arbitrary radial distance.

The terms “Diopter”, “Dioptre” or “D” as used herein is the unit measure of dioptric power, defined as the reciprocal of the focal distance of a lens or an optical system, in meters, along an optical axis. The term “DS” signifies spherical dioptric power, and term “DC” signifies cylindrical dioptric power.

The term “Min-Max power” means the difference between the maximum and the minimum powers within the asymmetrical power distribution for each outer semi-element of the extruded optical element with or without tilt.

The term “power profile” means the one-dimensional power distribution of localised optical power across the two combined outer semi-elements, either as a function of radial distance at a given azimuthal angle with the optical centre as a reference; or as a function of an azimuthal angle measured at a given radial distance.

The term “Spherical semi-outer element” means that the power is substantially uniform between all radial spokes of the outer semi-element of an extruded optical element with or without tilt.

The term “Toric semi-outer element” means that the power changes across the azimuth of the outer semi-element of an extruded optical element with or without tilt.

The term “Asymmetrical semi-outer element” means the asymmetrical power distributions for each outer semi-element of an extruded optical element with or without tilt.

The term “foveal correction” means a correction for the eye in at least the foveal region on the retina of the eye.

### SUMMARY OF THE INVENTION

Certain disclosed embodiments include spectacle lenses, devices, systems and/or methods for altering the characteristics of incoming light entering a human eye. Certain disclosed embodiments are directed to the configuration of spectacle lenses, methods and/or systems for correcting and treating refractive errors.

Certain embodiments of the disclosure are aimed to both correct the myopic refractive error and concomitantly provide an optical stop signal to discourage further progression of myopia. The disclosure relates to methods of correcting myopia, and controlling, inhibiting, or reducing the rate of myopia progression using tilted optical elements and/or extended optical elements with or without tilt, which are optimised to increase the light intensity of the TFRIS, e.g., at various visual field angles. The extended optical elements with or without tilt are exemplary features of this disclosure and shall be referred to as extruded optical elements with or without tilt for the rest of the disclosure.

The present disclosure relates to an optical intervention method that applies the effects of an increase in light intensity of the TFRIS (TFRIS) at various visual field angles to provide an optical stop signal or directional cue to reduce the rate of myopia progression.

This disclosure particularly relates to a myopia management spectacle lens with a central zone and at least one peripheral treatment zone, wherein the central zone is configured with a distance prescription to provide foveal correction for the myopic eye; wherein the at least one peripheral treatment zone is configured with a plurality of tilted optical elements surrounded by distance prescription; wherein the tilted optical elements are configured to increase the light intensity of the TFRIS as a function of visual field angle to provide directional cues to the peripheral retina, serving as an optical signal to provide a reduction of myopia progression to the myopic eye.

This disclosure further relates to a myopia management spectacle lens with a central zone and at least one peripheral treatment zone, wherein the central zone is configured with a distance prescription to provide foveal correction for the myopic eye; wherein the at least one peripheral treatment zone is configured with a plurality of extruded optical elements with or without tilt surrounded by distance prescription; wherein the extruded optical elements with or without tilt are configured to increase the light intensity of the TFRIS to provide directional cues to the peripheral retina, serving as an optical signal to provide a reduction of myopia progression to the myopic eye.

The altered optical signal achieved or provided by the introduction of an increase in light intensity of the TFRIS as a function of visual field angle may serve as a stop signal to a progressing myopic eye. The tilted optical elements and/or extruded optical elements and/or tilted extruded optical elements may either comprise surface alterations and/or alterations to the matrix of the material to provide an eye with a desirable level of light intensity when used in conjunction with the standard single vision integral base spectacle lens.

In some embodiments of the current disclosure, the central retinal portion of the myopia management spectacle wearer may include the central 1, 1.5, 2, 2.5, 3, 3.5, 4, 4.5 or 5-degree visual field. In some embodiments, the central retinal portion of the myopia management spectacle wearer may be circular. In some other embodiments of the current disclosure, the central zone of the myopia management spectacle lens may be oval, or non-circular, e.g., it may be extruded nasally or nasal-inferiorly to permit better near viewing through the central zone of the myopia management spectacle lens. In some embodiments, the peripheral retinal portion of the myopia management spectacle wearer may include the retinal field within a 5, 10, 15, 20, 25, or 30-degree visual field.

Certain embodiments are directed to devices, methods and/or systems that can impose an optical stop signal in one or more retinal locations of the wearers' eyes by using a plurality of tilted and/or extruded optical elements within or, as part of, in conjunction, or in juxtaposition with an integral base spectacle lens.

Certain embodiments are directed to devices, methods and/or systems that can modify incoming light through a myopia management spectacle lens to offer an increase in light intensity of the TFRIS to decelerate eye growth. This may be achieved via the use of a plurality of tilted optical elements and/or extruded optical elements and/or tilted extruded optical elements used in conjunction or combination with the standard single vision spectacle lenses. As per certain exemplary embodiments, a method for choosing a myopia management spectacle lens for an individual eye to control and/or inhibit the progression of myopia through the increase in light intensity of the TFRIS is described herein.

Certain embodiments are directed to optimised devices, methods and/or systems that increase the amount of the light intensity of the TFRIS at various visual field angles and increase the light intensity in front of the retina. This may be achieved via the use of a plurality of tilted optical elements and/or extruded optical elements and/or tilted extruded optical elements used in conjunction or combination with the standard single vision spectacle lenses. As per certain exemplary embodiments, a method for choosing a myopia management spectacle lens for an individual eye to control and/or inhibit the progression of myopia is described herein.

Certain embodiments of the current disclosure are directed to methods for reducing or slowing the eye growth. Certain embodiments of the present disclosure are directed to devices for reducing the rate of myopia progression. An exemplary method of the present disclosure comprises of a measurement of refraction of at least one of the eyes of a wearer; the method further identifying a distance prescription based at least in part on the refraction measurement of the eyes, the method further choosing a myopia management spectacle lens for each eye, wherein the myopia management spectacle lens is configured with an integral base spectacle lens with a base distance prescription power that is substantially close to the refraction measurement of the eye, and the integral base spectacle lens is further configured with a plurality of tilted optical elements and/or extruded optical elements and/or tilted extruded optical elements; wherein the plurality of tilted optical elements and/or extruded optical elements and/or tilted extruded optical elements are configured to provide an optical effect to the eye that is different to that provided by the integral base spectacle lens; and wherein the combination of the integral base spectacle lens and the plurality of tilted optical elements and/or extruded optical elements and/or tilted extruded optical elements is configured to provide an increase in light intensity of the TFRIS, e.g., as a function of visual field, on the retina of the myopic eye; which may further provide an optical signal to slow the progression of the length of the eye.

In addition to the embodiments discussed in the summary section, other embodiments are disclosed in the detailed specification, figures, example claim sets and claims. The summary is not meant to cover every embodiment, combination or variations contemplated with the present disclosure. This summary is not intended to be limiting as to the embodiments disclosed herein. Besides, limitations of one embodiment may be combined with limitations of other embodiments to form additional embodiments.

The embodiments presented in this disclosure are directed to the ongoing need for enhanced optical designs and spectacle lenses that may inhibit the progression of myopia while providing reasonable and adequate vision performance to the wearer for a range of activities that the wearer may undertake as a daily routine. Various aspects of the embodiments of the present invention disclosure address such needs of a wearer.

### BRIEF DESCRIPTION OF THE FIGURES

FIG. 1 illustrates the top view and the side view of a linear axicon.

FIG. 2 illustrates the top view and the side view of a lensacon.

FIG. 3 illustrates the top view and the side view of a tilted linear axicon.

FIG. 4 illustrates the top view and the side view of a tilted lensacon with circular base.

FIG. 5 illustrates the top view and the side view of a tilted lensacon with an elliptical base.

FIG. 6 illustrates a 3D image of a tilted lensacon with an elliptical base and a tilted axicon with an elliptical base.

FIG. 7 illustrates the schematic diagram of a myopia management spectacle lens embodiment of the present disclosure, wherein the optical zone is configured of a substantially circular central distance zone with single vision correction and a peripheral treatment zone with tilted lensacons surrounded by areas with single vision correction.

FIG. 8 illustrates an extruded optical element that comprises of two outer semi-elements and a connecting element.

FIG. 9 illustrates the top, front, and side views of an extruded optical element with two spherical outer semi-elements and a spherical connecting element.

FIG. 10 illustrates the top, front, and side views of an extruded optical element with one spherical outer semi-element, one toric outer semi-element and a spherical connecting element.

FIG. 11 illustrates the top, front, and side views of an extruded optical element with two outer semi-axicons and an axicon-like connecting element.

FIG. 12 illustrates the top, front, and side views of an extruded optical element with two outer semi-lensacons and a lensacon-like connecting element.

FIG. 13 illustrates the top, front, and side views of an extruded optical element with two outer semi-axicons and a lensacon-like tilted connecting element.

FIG. 14 shows the top views of various combinations of extruded optical element exemplary embodiments of the current disclosure representing different shapes and profiles of the outer semi-elements and with connecting elements of different profiles wherein the axis of the connecting element is either centred or tilted.

FIG. 15 illustrates the top view and a 3D image of an extruded optical element with two spherical outer semi-elements and a connecting element with a spherical profile and centred axis.

FIG. 16 illustrates the top view and a 3D image of an extruded optical element with two spherical outer semi-elements and a connecting element with a lensacon-like profile and centred axis.

FIG. 17 illustrates the top view and a 3D image of an extruded optical element with axicon-like outer semi-elements and a connecting element with an axicon-like profile and centred axis.

FIG. 18 illustrates the top view and a 3D image of an extruded optical element with a spherical outer semi-element, a toric outer semi-element and a connecting element with a spherical profile and centred axis.

FIG. 19 illustrates the top view and a 3D image of an extruded optical element with a spherical outer semi-element, an axicon semi-element and a connecting element with a spherical profile and centred axis.

FIGS. 20 and 21 are not included in this specification.

FIG. 22 illustrates the schematic diagram of a spectacle lens embodiment of the present disclosure, wherein the optical zone is configured of a substantially circular central distance zone with single vision correction and a peripheral treatment zone with tilted extruded optical elements surrounded by areas with single vision correction.

FIG. 23 illustrates a schematic diagram of an on-axis and off-axis, TFRIS, when the incoming light, with a visible wavelength (555 nm) and vergence of 0 D, depicting optical infinity, is incident on a −2 D myopic model eye corrected with a lenslet based spectacle lens of prior art.

FIG. 24 illustrates a schematic diagram of an on-axis and off-axis, TFRIS, when the incoming light, with a visible wavelength (555 nm) and vergence of 0 D, depicting optical infinity, is incident on a −2 D myopic model eye corrected with a spectacle lens with axicons as disclosed previously in WO 2021/159170.

FIG. 25 illustrates a schematic diagram of an on-axis and off-axis, TFRIS, when the incoming light, with a visible wavelength (555 nm) and vergence of 0 D, depicting optical infinity, is incident on a −2 D myopic model eye corrected with a myopia management spectacle lens embodiment of the current disclosure with tilted optical elements, i.e., tilted linear axicons.

FIG. 26 illustrates a schematic diagram of an on-axis and off-axis, TFRIS, when the incoming light, with a visible wavelength (555 nm) and vergence of 0 D, depicting optical infinity, is incident on a −2 D myopic model eye corrected with a myopia management spectacle lens embodiment of the current disclosure with extruded optical elements (with or without tilt), wherein the parameters of the tilted optical elements result in an increase of the light intensity of the TFRIS when compared to a spectacle lens as disclosed previously in WO 2021/159170 and/or wherein the parameters of the tilted optical elements result in a non-uniform light intensity of the TFRIS wherein the magnitude in light intensity is greater in front of the retina when compared to behind the retina.

FIG. 27 illustrates a schematic diagram of a myopia management spectacle lens embodiment of the present disclosure, wherein the optical zone is configured of a substantially circular central distance zone with single vision correction and a peripheral treatment zone with tilted lensacons surrounded by areas with single vision correction.

FIG. 28 illustrates a schematic diagram of a myopia management spectacle lens embodiment of the present disclosure, wherein the optical zone is configured of a substantially circular central distance zone with single vision correction and three peripheral treatment zones with lensacons with and without tilt surrounded by areas with single vision correction.

FIG. 29 illustrates a schematic diagram of a myopia management spectacle lens embodiment of the present disclosure, wherein the optical zone is configured of a substantially circular central distance zone with single vision correction and three peripheral treatment zones with lensacons with and without tilt surrounded by areas with single vision correction wherein the amount of tilt and the size of the curved apex of the lensacons are different between the peripheral treatment zones, i.e., it increases toward the periphery.

FIG. 30 illustrates a schematic diagram of a myopia management spectacle lens embodiment of the present disclosure, wherein the optical zone is configured of a substantially circular central distance zone with single vision correction and three peripheral treatment zones with lensacons with and without tilt surrounded by areas with single vision correction wherein the size, the amount of tilt and the size of the curved apex of the lensacons are different between the peripheral treatment zones, i.e., it increases toward the periphery.

FIG. 31 illustrates a schematic diagram of a myopia management spectacle lens embodiment of the present disclosure, wherein the optical zone is configured of a substantially circular central distance zone with single vision correction and two peripheral treatment zones with extruded optical elements, configured of two spherical outer semi-elements and a connecting element with spherical profile and centred axis.

FIG. 32 illustrates a schematic diagram of a myopia management spectacle lens embodiment of the present disclosure, wherein the optical zone is configured of a substantially circular central distance zone with single vision correction and two peripheral treatment zones with extruded optical elements, configured of two asymmetrical outer semi-elements and a connecting element with lensacon-like profile and tilted axis.

FIG. 33 illustrates a schematic diagram of a myopia management spectacle lens embodiment of the present disclosure, wherein the optical zone is configured of a substantially circular central distance zone with single vision correction and three peripheral treatment zones with tilted lensacons and extruded optical elements, wherein the extruded optical elements are configured of two asymmetrical outer semi-elements and a connecting element with lensacon-like profile and tilted axis.

FIG. 34 illustrates a schematic diagram of a myopia management spectacle lens embodiment of the present disclosure, wherein the optical zone is configured of a substantially circular central distance zone with single vision correction and three peripheral treatment zones with extruded optical elements, wherein the extruded optical elements are configured of two asymmetrical outer semi-elements and a connecting element with lensacon-like profile and tilted axis, and wherein the tilt increases toward the periphery of the spectacle lens and the width of the curved top of the lensacon-like profile is substantially similar for all extruded optical elements.

FIG. 35 illustrates a schematic diagram of a myopia management spectacle lens embodiment of the present disclosure, wherein the optical zone is configured of a substantially circular central distance zone with single vision correction and three peripheral treatment zones with extruded optical elements, wherein the extruded optical elements are configured of two asymmetrical outer semi-elements and a connecting element with lensacon-like profile and tilted axis, and wherein the tilt and the width of the curved top of the lensacon-like profile increase toward the periphery of the spectacle lens.

FIG. 36 illustrates a schematic diagram of a myopia management spectacle lens embodiment of the present disclosure, wherein the optical zone is configured of a substantially circular central distance zone with single vision correction and three peripheral treatment zones with extruded optical elements, wherein the extruded optical elements are configured of two asymmetrical outer semi-elements and a connecting element with lensacon-like profile and tilted axis, and wherein the size of the extruded optical elements and the tilt and the width of the curved top of the lensacon-like profile increase toward the periphery of the spectacle lens.

FIG. 37 illustrates a schematic diagram of a myopia management spectacle lens embodiment of the present disclosure, wherein the optical zone is configured of a substantially circular central distance zone with single vision correction and a peripheral treatment zone with extruded optical elements, wherein the extruded optical elements are configured of one toric and one spherical outer semi-elements and a connecting element with axicon-like profile.

FIG. 38 illustrates a schematic diagram of a vector tilt transformation that was applied to an axicon resulting in a tilted axicon with a base shape that is non-circular and non-elliptical.

FIG. 39 compares the off-axis through-focus MTFs obtained through a spectacle lens (Rx: −3 D) configured with an axicon without tilt (as described in FIG. 24 and as disclosed previously in WO 2021/159170) and a spectacle lens (Rx: −3 D) configured with a tilted axicon (as described in FIG. 25 and as detailed in the current disclosure) featuring 0.13 mm tilt, to correct a −3 D myopic model eye. The through-focus MTF was obtained at a field angle of (0, 28) degrees.

FIG. 40 compares the off-axis through-focus MTFs obtained through a spectacle lens (Rx: −3 D) configured with an axicon without tilt (as described in FIG. 24 and as disclosed previously in WO 2021/159170) and a spectacle lens (Rx: −3 D) configured with a tilted axicon (as described in FIG. 25 and as detailed in the current disclosure) featuring 0.19 mm tilt, to correct a −3 D myopic model eye. The through-focus MTF was obtained at a field angle of (0, 33) degrees.

FIG. 41 compares the off-axis through-focus MTFs obtained through a spectacle lens (Rx: −3 D) configured with an axicon without tilt (as described in FIG. 24 and as disclosed previously in WO 2021/159170) and a spectacle lens (Rx: −3 D) configured with a tilted axicon (as described in FIG. 25 and as detailed in the current disclosure) featuring 0.23 mm tilt, to correct a −3 D myopic model eye. The through-focus MTF was obtained at a field angle of (0, 36) degrees.

FIG. 42 compares the off-axis through-focus MTFs obtained through a spectacle lens (Rx: −3 D) configured with an axicon without tilt (as described in FIG. 24 and as disclosed previously in WO 2021/159170) and a spectacle lens (Rx: −3 D) configured with a tilted axicon (as described in FIG. 25 and as detailed in the current disclosure) featuring 0.25 mm tilt, to correct a −3 D myopic model eye. The through-focus MTF was obtained at a field angle of (0, 40) degrees.

FIG. 43 compares the off-axis through-focus MTFs obtained through a spectacle lens (Rx: −3 D) configured with a lensacon without tilt (as described in FIG. 2 and as disclosed previously in WO 2021/159170) and a spectacle lens (Rx: −3 D) configured with a tilted lensacon (as described in FIGS. 4 and 5 and as detailed in the current disclosure) featuring 0.13 mm tilt, to correct a −3 D myopic model eye. The through-focus MTF was obtained at a field angle of (0, 28) degrees.

FIG. 44 compares the off-axis through-focus MTFs obtained through a spectacle lens (Rx: −3 D) configured with a lensacon without tilt (as described in FIG. 2 and as disclosed previously in WO 2021/159170) and a spectacle lens (Rx: −3 D) configured with a tilted lensacon (as described in FIGS. 4 and 5 and as detailed in the current disclosure) featuring 0.19 mm tilt, to correct a −3 D myopic model eye. The through-focus MTF was obtained at a field angle of (0, 33) degrees.

FIG. 45 compares the off-axis through-focus MTFs obtained through a spectacle lens (Rx: −3 D) configured with a lensacon without tilt (as described in FIG. 2 and as disclosed previously in WO 2021/159170) and a spectacle lens (Rx: −3 D) configured with a tilted lensacon (as described in FIGS. 4 and 5 and as detailed in the current disclosure) featuring 0.23 mm tilt, to correct a −3 D myopic model eye. The through-focus MTF was obtained at a field angle of (0, 36) degrees.

FIG. 46 compares the off-axis through-focus MTFs obtained through a spectacle lens (Rx: −3 D) configured with a lensacon without tilt (as described in FIG. 2 and as disclosed previously in WO 2021/159170) and a spectacle lens (Rx: −3 D) configured with a tilted lensacon (as described in FIGS. 4 and 5 and as detailed in the current disclosure) featuring 0.25 mm tilt, to correct a −3 D myopic model eye. The through-focus MTF was obtained at a field angle of (0, 40) degrees.

FIG. 47 illustrates a schematic diagram of an extrusion transformation that was applied to a reference axicon resulting in an extruded optical element through an extension or extrusion along the y axis of the reference axicon.

FIG. 48 compares the off-axis through-focus MTFs obtained through a spectacle lens (Rx: −3 D) configured with an extruded axicon without tilt (as described in FIGS. 11 and 14 of the current disclosure) and a spectacle lens (Rx: −3 D) configured with a tilted extruded axicon (as described in FIG. 14 of the current disclosure) featuring 0.17 mm tilt, to correct a −3 D myopic model eye. The through-focus MTF was obtained at a field angle of (0, 28) degrees.

FIG. 49 compares the off-axis through-focus MTFs obtained through a spectacle lens (Rx: −3 D) configured with an extruded axicon without tilt (as described in FIGS. 11 and 14 of the current disclosure) and a spectacle lens (Rx: −3 D) configured with a tilted extruded axicon (as described in FIG. 14 of the current disclosure) featuring 0.2 mm tilt, to correct a −3 D myopic model eye. The through-focus MTF was obtained at a field angle of (0, 33) degrees.

FIG. 50 compares the off-axis through-focus MTFs obtained through a spectacle lens (Rx: −3 D) configured with an extruded axicon without tilt (as described in FIGS. 11 and 14 of the current disclosure) and a spectacle lens (Rx: −3 D) configured with a tilted extruded axicon (as described in FIG. 14 of the current disclosure) featuring 0.15 mm tilt, to correct a −3 D myopic model eye. The through-focus MTF was obtained at a field angle of (0, 36) degrees.

FIG. 51 compares the off-axis through-focus MTFs obtained through a spectacle lens (Rx: −3 D) configured with an extruded axicon without tilt (as described in FIGS. 11 and 14 of the current disclosure) and a spectacle lens (Rx: −3 D) configured with a tilted extruded axicon (as described in FIG. 14 of the current disclosure) featuring 0.15 mm tilt, to correct a −3 D myopic model eye. The through-focus MTF was obtained at a field angle of (0, 40) degrees.

FIG. 52 compares the off-axis through-focus MTFs obtained through a spectacle lens (Rx: −3 D) configured with an extruded lensacon without tilt (as described in FIGS. 12, 14 and 16 of the current disclosure) and a spectacle lens (Rx: −3 D) configured with a tilted extruded lensacon (as described in FIG. 14 of the current disclosure) featuring 0.15 mm tilt, to correct a −3 D myopic model eye. The through-focus MTF was obtained at a field angle of (0, 28) degrees.

FIG. 53 compares the off-axis through-focus MTFs obtained through a spectacle lens (Rx: −3 D) configured with an extruded lensacon without tilt (as described in FIGS. 12, 14 and 16 of the current disclosure) and a spectacle lens (Rx: −3 D) configured with a tilted extruded lensacon (as described in FIG. 14 of the current disclosure) featuring 0.3 mm tilt, to correct a −3 D myopic model eye. The through-focus MTF was obtained at a field angle of (0, 33) degrees.

FIG. 54 compares the off-axis through-focus MTFs obtained through a spectacle lens (Rx: −3 D) configured with an extruded lensacon without tilt (as described in FIGS. 12, 14 and 16 of the current disclosure) and a spectacle lens (Rx: −3 D) configured with a tilted extruded lensacon (as described in FIG. 14 of the current disclosure) featuring 0.35 mm tilt, to correct a −3 D myopic model eye. The through-focus MTF was obtained at a field angle of (0, 36) degrees.

FIG. 55 compares the off-axis through-focus MTFs obtained through a spectacle lens (Rx: −3 D) configured with an extruded lensacon without tilt (as described in FIGS. 12, 14 and 16 of the current disclosure) and a spectacle lens (Rx: −3 D) configured with a tilted extruded lensacon (as described in FIG. 14 of the current disclosure) featuring 0.10 mm tilt, to correct a −3 D myopic model eye. The through-focus MTF was obtained at a field angle of (0, 40) degrees.

FIG. 56 illustrates a schematic diagram of an on-axis and off-axis, TFRIS, when the incoming light, with a visible wavelength (555 nm) and vergence of 0 D, depicting optical infinity, is incident on a −2 D myopic model eye corrected with a myopia management spectacle lens embodiment of the current disclosure with tilted optical elements, i.e., tilted linear axicons, wherein the parameters of the tilted optical elements result in increased light intensity of the TFRIS behind the retina.

FIG. 57 compares the off-axis through-focus MTFs obtained through a spectacle lens (Rx: −3 D) configured with an axicon without tilt (as described in FIG. 24 and as disclosed previously in WO 2021/159170) and a spectacle lens (Rx: −3 D) configured with a tilted axicon (as described in FIG. 14 of the current disclosure) featuring −0.550 mm tilt, to correct a −3 D myopic model eye. The through-focus MTF was obtained at a field angle of (0, 33) degrees.

FIG. 58 compares the off-axis through-focus MTFs obtained through a spectacle lens (Rx: −3 D) configured with a tilted axicon (as described in FIG. 25 of the current disclosure) featuring 0.13 mm tilt and a spectacle lens (Rx: −3 D) configured with a tilted extruded axicon (as described in FIG. 14 of the current disclosure) featuring 0.17 mm tilt, to correct a −3 D myopic model eye. The through-focus MTF was obtained at a field angle of (0, 28) degrees.

FIG. 59 illustrates a schematic diagram of a vector tilt transformation that was applied to an axicon resulting in a tilted axicon with a base shape that is circular.

FIG. 60 illustrates the top view and the side view of a tilted lensacon with a non-circular, non-elliptical base.

### DETAILED DESCRIPTION

In this section, the present disclosure will be described in detail with reference to one or more embodiments, some are illustrated and supported by accompanying figures. The examples and embodiments are provided by way of explanation and are not to be construed as limiting to the scope of the disclosure. The following description is provided in relation to several embodiments that may share common characteristics and features of the disclosure. It is to be understood that one or more features of one embodiment may be combined with one or more features of any other embodiments which may constitute additional embodiments.

The functional and structural information disclosed herein is not to be interpreted as limiting in any way and should be construed merely as a representative basis for teaching a person skilled in the art to employ the disclosed embodiments and variations of those embodiments in various ways. The sub-titles and relevant subject headings used in the detailed description section have been included only for the ease of reference for the reader and in no way should be used to limit the subject matter found throughout the invention or the claims of the disclosure. Further, the sub-titles and relevant subject headings should not be used in construing the scope of the claims or the claim limitations.

The prior art spectacle designs for the management of myopia include use of executive bifocals, D-shaped bifocals, concentric bifocals, conventional progressive additional lenses, and special-type of progressive addition lenses, including symmetric and asymmetric versions, multifocals, incorporation of multi-segment defocus regions on the spectacle lenses, and spectacles with positive spherical aberration, which may be referred to as peripheral plus lenses. Each of these spectacle lens designs has its strengths and weaknesses. Some of the weaknesses are described herein. For example, some are based on various types of bifocal, multifocal and progressive lenses or peripheral plus power, compromise the quality of vision at peripheral viewing angles by introducing significant visual disturbances like swing-effects, image-jumps, residual aberrations, and peripheral distortions. The side effects are attributable to the significant levels of simultaneous and/or multiple defocus regions, zones, or segments, or use of significant amounts of positive spherical aberration in the lens, or a drastic change in the power within a given zone of the spectacle lens.

Progressive addition spectacle lenses, which are the gold standard for the management of presbyopia, have been tested for management of myopia with barely any notable effectiveness, as gauged by multiple randomised controlled clinical trials. Further, the outcomes of several attempts to modify progressive addition lens designs, incorporating relevant optical features considering variations in younger eyes, have also been largely fruitless. The underlying reason for observed futility in relation to ineffective management of myopia with progressive and other conventional bifocal and multifocal spectacle lenses can be funneled down two reasons: (a) the optical correction being dependent on the gaze of the wearer, in other words, a choice for the wearer to either use or disregard the treatment optics within the spectacle lens; and/or (b) the remoteness of the treatment zone to the pupillary region/visual axis of the wearer.

For example, the spectacle lens designs that have factored in the above limitations of the prior art into the design development have demonstrated greater success in reducing the progression of myopia compared to the designs incorporating traditional or conventional bifocal, multifocal or progressive addition ‘like’ optics within the spectacle lenses.

Following references are incorporated herein in its entirety to the support the above finding. To et al, U.S. patent Ser. No. 10/268,050B2 teaches the use of defocus incorporated multi-segment optical elements to control myopia progression. A peer-reviewed scientific paper by Lam et al, Br J Ophthalmol, 2019, 104, 363-368 titled “Defocus Incorporated Multiple Segments (DIMS) spectacle lenses slow myopia progression: a 2-year randomised clinical trial” demonstrates the clinical utility of U.S. Pat. No. 10,268,050B2. Following the first successful approach to manage progressive myopia using defocus incorporated multi-segment lenses disclosed in the prior art U.S. Pat. No. 10,268,050B2, there has been a rush by the ophthalmic industry into lenslets and microlenslets based technologies incorporated into spectacle lenses, aimed at improving upon the established prior art 10268050B2, for both spectacle and contact lens modes of applications. Following references are incorporated herein in its entirety that relates to contact lens-based applications. For example, Brennan et al, US patent 2016/0377884 A1 titled “Contact Lens comprising non-co-axial micro lenslets for preventing and/or slowing myopia progression” teaches the use of a plurality of non-coaxial lenslets or optical elements for myopia progression. This disclosure US patent 2016/0377884 A1 contemplates the use of high magnitudes of defocus incorporated into small regions within the contact lens optic zone to manage myopia. Further, in another patent application titled “Apparatus and methods for controlling axial growth with an ocular lens”, Newman discloses the use of a plurality of optical elements or features aimed to redirect peripheral light into the eye away from the central region of the retina to prevent progression of myopia.

Following references are incorporated herein in its entirety that relates to spectacle lens-based applications claiming improvements over the prior art 10268050B2. For example, Matthieu et al, patent application WO 2019/166659 A9 titled “Optical Lens Element” discloses the use of aspheric optics in regional optical elements and use of a plurality of at least two contiguous optical elements configured to effectively slow the progression of myopia. The utility of the aspheric optics instead of conventional spherical optics described in prior art 10268050B2 and the specific arrangement of the contemplated aspheric optics is claimed to have improvements over the prior art. Further, Matthieu et al, patent application WO 2020/079105 A1 titled “Optical Lens” teaches additional means of determining an optical lens element used in conjunction with spectacle lenses for controlling the progression of myopia.

In the patent application WO 2020/078691 A1 titled “Optical Articles comprising encapsulated microlenses and methods of making the same”, Matthieu et al expands the utilization of a plurality of optical elements such as microlenses on the lens surface that can facilitate desired positive addition power to focus part of the incoming light in front of the retina and control progression of myopia. In a further set of improvements over the disclosure of defocus incorporated multi-segment based optical elements described in prior art U.S. Pat. No. 10,268,050B2, Saux et al, in patent application WO 2020/078964 A1 titled “Improved Optical Article Incorporating Optical Elements and Manufacturing Method thereof” further teaches the use of microlenses utilising Fresnel structures embedded into spectacle lenses to prevent progression of myopia.

In another mode of application, Bakaraju et al in US patent US20200073147A1 propose the use of microlenses incorporated within spectacle lenses to provide chromatic cues to the eye that facilitates deceleration in the rate of myopia progression. Briefly summarised, all lenslet based technologies proposed for myopic eyes involve the imposition of some level of defocus in the central and/or peripheral region of the retina using defocus or aspheric lenslets. Furthermore, various arrangements of the lenslet ‘like’ features to be incorporated within the spectacle lenses have been contemplated to improve on visual performance. See examples in U.S. Pat. No. 10,268,050B2, patent applications WO 2019/166659 A9, WO 2020/079105 A1, WO 2020/078691, WO 2020/078964 A1 and US 2020/0073147A1.

The next generation spectacle solutions for myopia management contemplated in the current disclosure are aimed at optimising the directional cues delivered to the peripheral retina using a spectacle lens configured with a plurality of optical elements and/or extruded optical elements with and without tilt to increase the light intensity of the through-focus retinal spread, e.g., as a function of visual field angle.

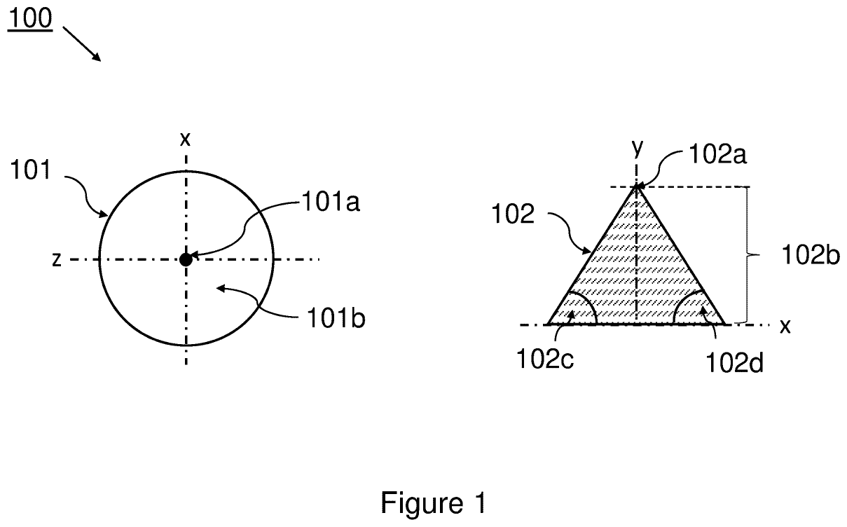

FIG. 1 illustrates the top view (101) and the side view (102) of an optical element, i.e., a linear axicon (100), which resembles the shape of a cone. The top view (101) of the linear axicon illustrates the apex (101a) located at its geometrical centre and the circular base shape (101b). The side view (102) of the axicon illustrates the apex (102a), the height (102b) and the steepness of the axicon as defined by the angles (102c) and (102d).

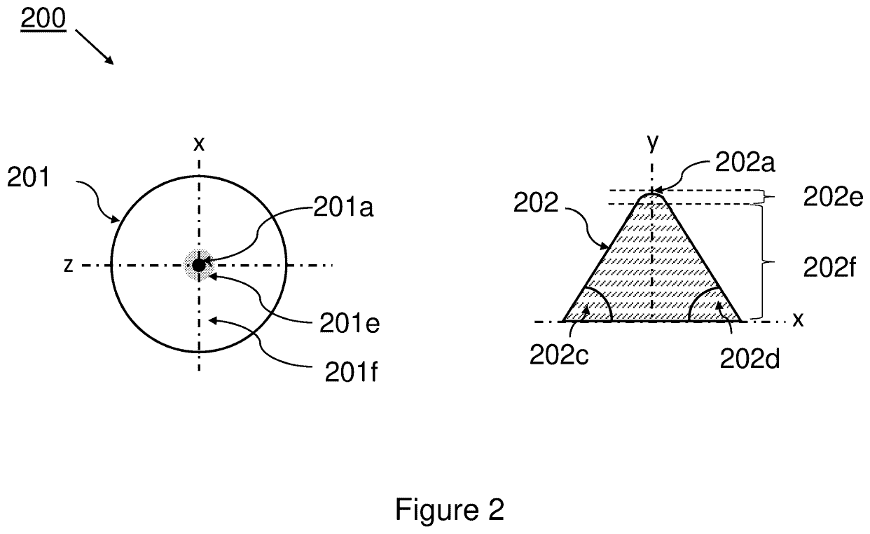

FIG. 2 illustrates the top view (201) and the side view (202) of an optical element, i.e., a lensacon (200), which resembles the shape of a cone with a curved top or a curved lens top. Alternatively, a lensacon can be described as an optical element that is a combination of a linear axicon and a lens. The top view (201) of the lensacon illustrates the apex (201a) located at its geometrical centre, the size of the circular curved lens top (201e) and the size of the circular base shape (201f). The side view (202) of the lensacon illustrates the apex (202a), the height of the lensacon as defined by the combined height of the curved lens top (202e) and the height of the lower axicon part (202f), and the steepness of the lensacon as defined by the angles (202c) and (202d).

Both optical elements, i.e., the linear axicon and the lensacon as well as other rotationally symmetric axicon-like elements have been described previously for use in a spectacle lens for managing myopia progression in the related disclosure WO 2021/159170.

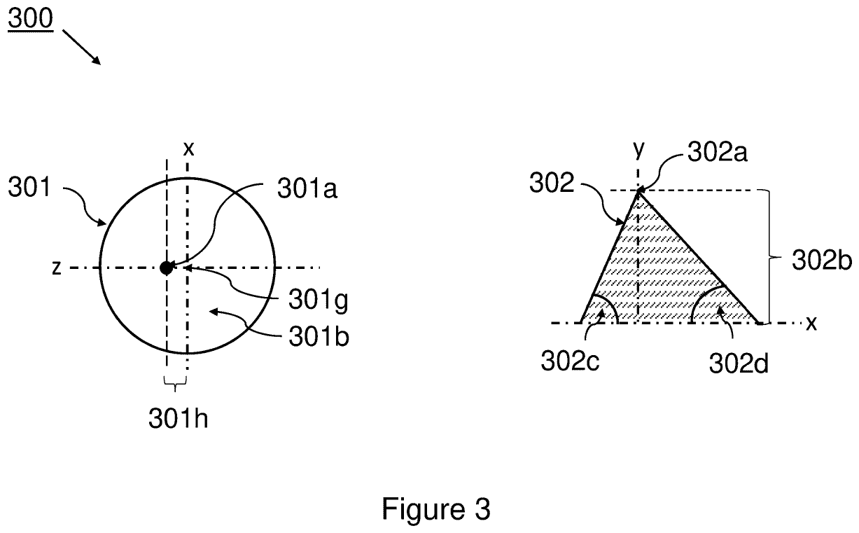

FIGS. 3 to 6 describe non-rotationally symmetric axicon-like or lensacon-like optical elements, i.e., optical elements with a tilt, for use in a myopia management spectacle lens embodiment of the current disclosure. Aligning the tilt of the optical elements on the myopia management spectacle lens with respect to the centre of the pupil of the eye can increase the light intensity of the TFRIS at various visual field angles which, when compared to the previous disclosure WO 2021/159170, may provide stronger directional cues or stop signals for the peripheral retina, and thus provide better means to slow eye growth.

FIG. 3 illustrates the top view (301) and the side view (302) of a tilted optical element, i.e., a tilted linear axicon (300), which resembles the shape of a tilted cone. The top view (301) of the tilted linear axicon illustrates the apex (301a) that is decentered from the geometrical centre (301g) by distance (301h), and the circular base shape (301b). The side view (302) of the tilted linear axicon illustrates the apex (302a), the height (302b) and the steepness and tilt of the tilted linear axicon as defined by the angles (302c) and (302d).

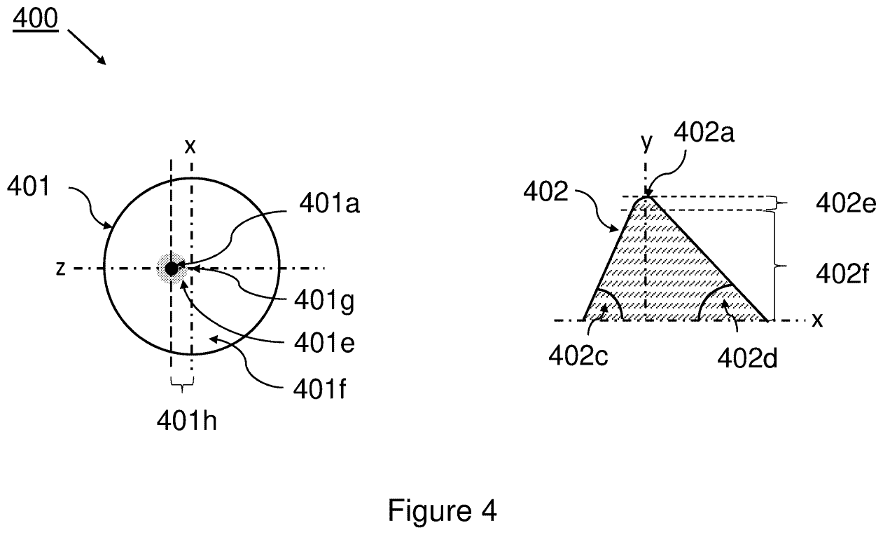

FIG. 4 illustrates the top view (401) and the side view (402) of a tilted optical element, i.e., a tilted lensacon (400), which resembles the shape of a tilted cone with a curved lens top. The top view (401) of the tilted lensacon illustrates the size of the lens top (401e) and the size of the circular base (401f). The top view (401) of the tilted lensacon further illustrates the tilted lensacon with an apex (401a) that is decentered from the geometrical centre (401g) of the circular base (401f) by distance (401h). The side view (402) of the tilted lensacon illustrates the apex (402a) and the height of the tilted lensacon as defined by the combined height of the curved lens top (402e) and the height of the lower axicon part (402f). The side view (402) further illustrates the steepness and the tilt of the tilted lensacon as defined by the angles (402c) and (402d).

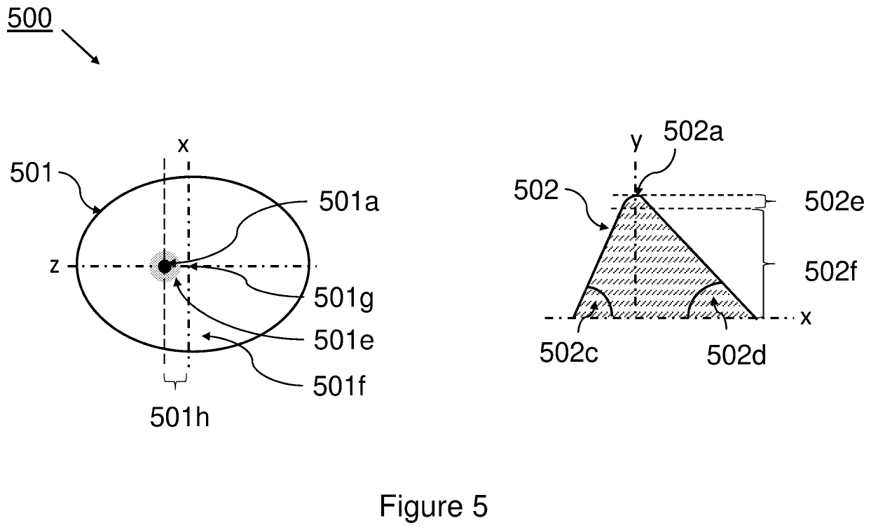

FIG. 5 illustrates the top view (501) and the side view (502) of a tilted optical element, i.e., a tilted lensacon (500), which resembles the shape of a tilted cone with a curved lens top. The top view (501) of the tilted lensacon illustrates the size of the lens top (501e) and the size of the elliptical base (501f). The top view (501) of the tilted lensacon further illustrates the tilted lensacon with an apex (501a) that is decentered from the geometrical centre (501g) of the elliptical base (501f) along the z-axis by distance (501h). The side view (502) of the tilted lensacon illustrates the apex (502a) and the height of the tilted lensacon as defined by the combined height of the curved lens top (502e) and the height of the lower axicon part (502f). The side view (502) further illustrates the steepness and the tilt of the tilted lensacon as defined by the angles (502c) and (502d). The shape of the base of the tilted optical element may be selected taking into consideration the ease of manufacture on any of the two spectacles lens surfaces, which may be spherical or aspherical.

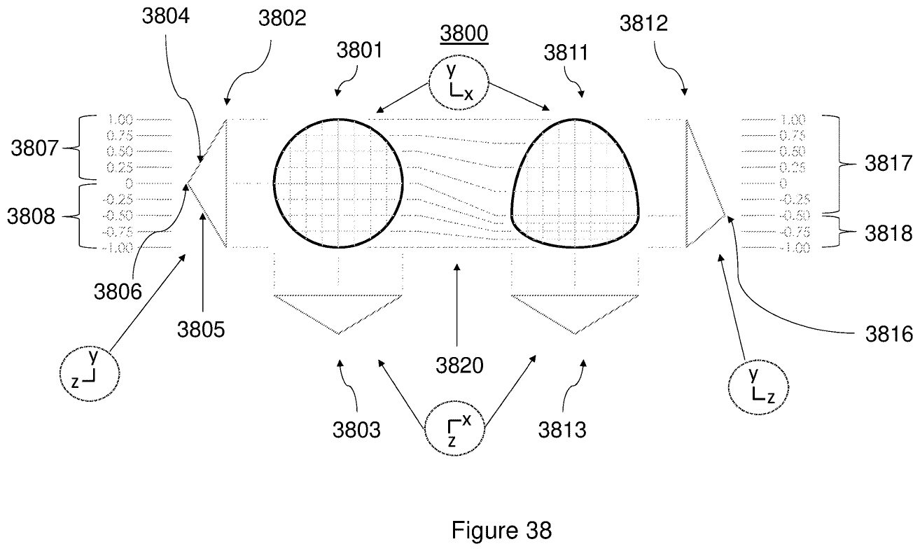

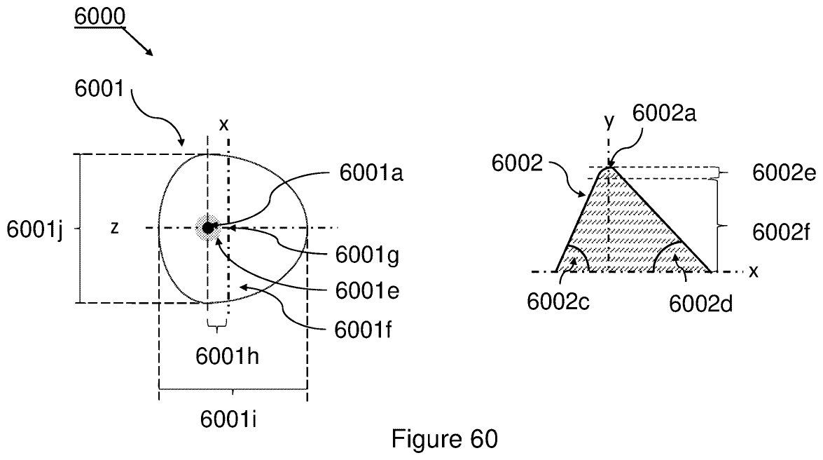

In some examples, the shape of the base of the tilted optical elements may be circular or elliptical. In other examples of the current disclosure, the shape of the base of the tilted optical elements may be non-circular, non-elliptical or resemble the combination of two semi-ellipses of different sizes (see FIGS. 38 and 60).

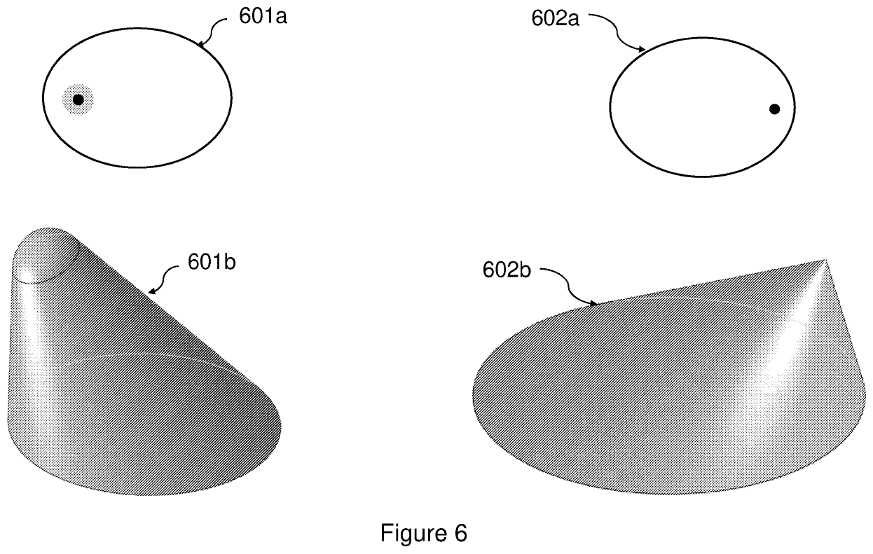

FIG. 6 illustrates the top view (601a) and a 3D image (601b) of a tilted lensacon with elliptical base, as described in FIG. 5, as well as the top view (602a) and a 3D image (602b) of a tilted linear axicon with elliptical base.

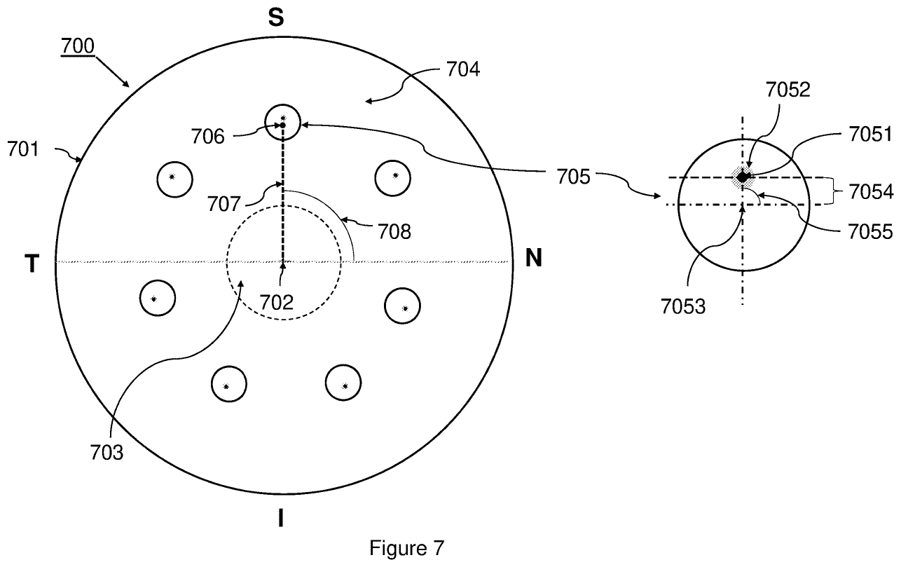

FIG. 7 illustrates the schematic diagram (left) of a myopia management spectacle lens embodiment (700) of the present disclosure, wherein the optical zone (701) with an optical centre (702) is configured of a substantially circular central distance zone (703) with single vision correction and a peripheral treatment zone (704) with tilted lensacons (705) with circular base, as described in FIG. 4, surrounded by areas with single vision correction. The location of each tilted lensacon (705) within the spectacle lens embodiment is defined by a distance (707) between the optical centre (702) and the geometric centre (706) of the tilted lensacon (705) as well as by the azimuthal angle (708).

FIG. 7 further illustrates a zoomed in version of the tilted lensacon (705, right), wherein the apex (7051) with the curved lens top (7052) is decentred from the geometrical centre (7053) by the distance (7054) and wherein the direction of the tilted apex within the spectacle lens embodiment is further defined by the azimuthal angle (7055).

In other examples, the optical elements in the spectacle lens embodiment may be tilted linear axicons with circular base, tilted linear axicons with elliptical base, tilted axicon-like elements (e.g., logarithmic axicons, fraxicons) with circular or elliptical base or tilted lensacons with elliptical base. In other examples, the optical elements in the spectacle lens embodiment may be combinations of different tilted optical elements or combinations of centred and tilted optical elements, that change in amount of tilt and/or in size as a function of visual field angle. In other examples, where the spectacle lens embodiment comprises tilted lensacons or a combination of tilted lensacons and centred lensacons, the size of the curved lens top of the lensacons may also vary as a function of visual field and/or as a function of through-focus light intensity. In other examples, the central distance zone may be non-circular or elliptical.

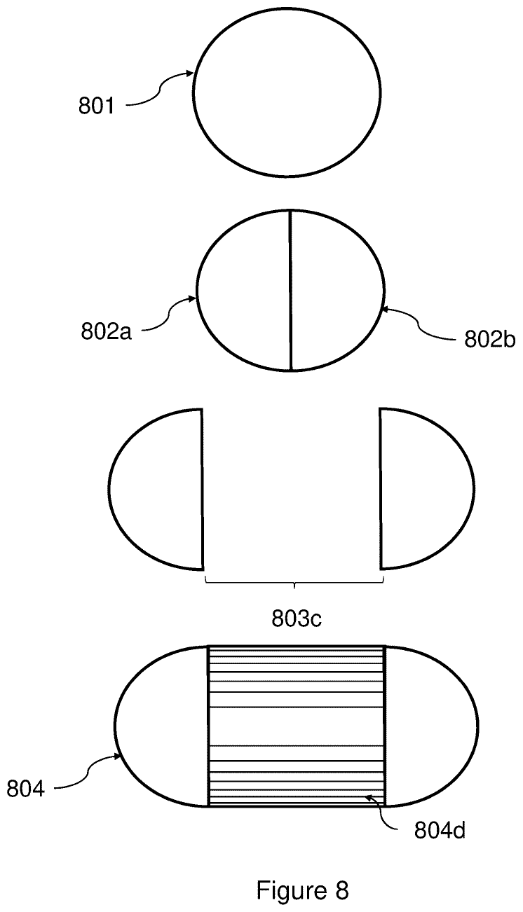

FIGS. 8 to 13 describe extruded optical elements for use in a myopia management spectacle lens embodiment of the current disclosure.

FIG. 8 illustrates the top view of an optical element, such as a spherical lenslet of prior Art (801). To form an extruded optical element (804) for a myopia management spectacle lens embodiment of the current disclosure, the spherical lenslet (801) is bisected into two spherical semi-elements (802a and 802b), is separated by gap (803c) and filled with a connecting element (804d). In this example, the profiles of the two outer semi-elements and the connecting element are spherical. In other examples, the profile of at least one of the two outer semi-elements may be toric, asymmetrical, aspheric, axicon-like, lensacon-like, fraxicon-like, axilens-like etc.

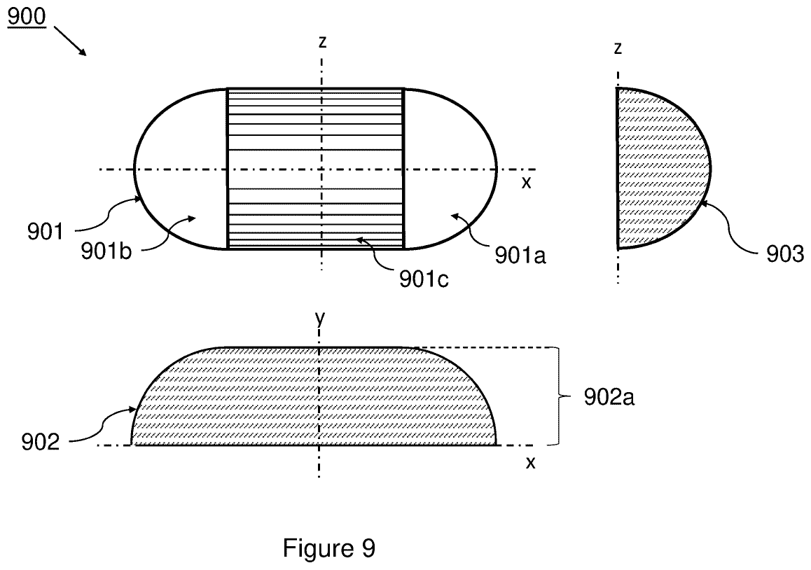

FIG. 9 illustrates the top (901), front (902), and side (903) views of an extruded optical element (900) of the current disclosure configured of two spherical outer semi-elements (901a and 901b) and a connecting element (901c) with a spherical profile (903) and a height (or peak sag) of 902a, wherein the axis of the connecting element is centred along the x-axis.

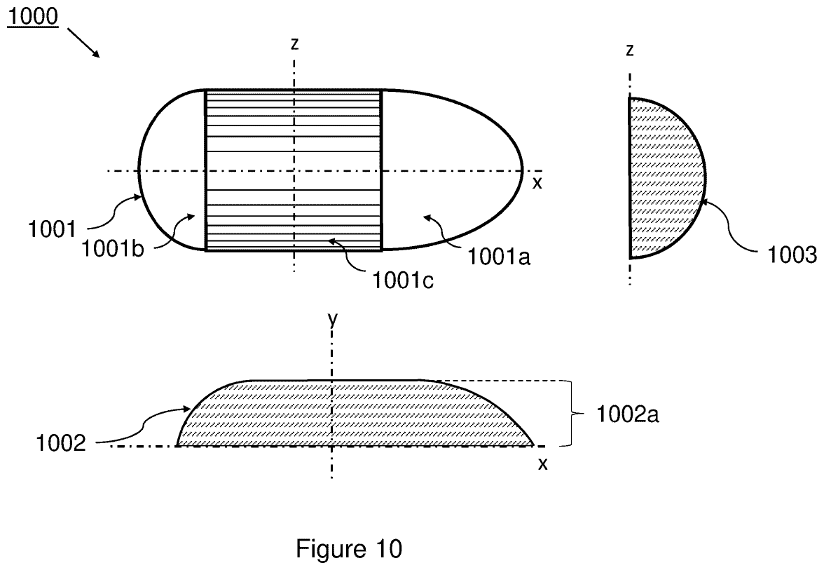

FIG. 10 illustrates the top (1001), front (1002), and side (1003) views of an extruded optical element (1000) of the current disclosure configured of one toric outer semi-element (1001a), one spherical outer semi-element (1001b) and a connecting element (1001c) with a spherical profile (1003) and a height (or peak sag) of 1002a, wherein the axis of the connecting element (1001c) is centred along the x-axis.

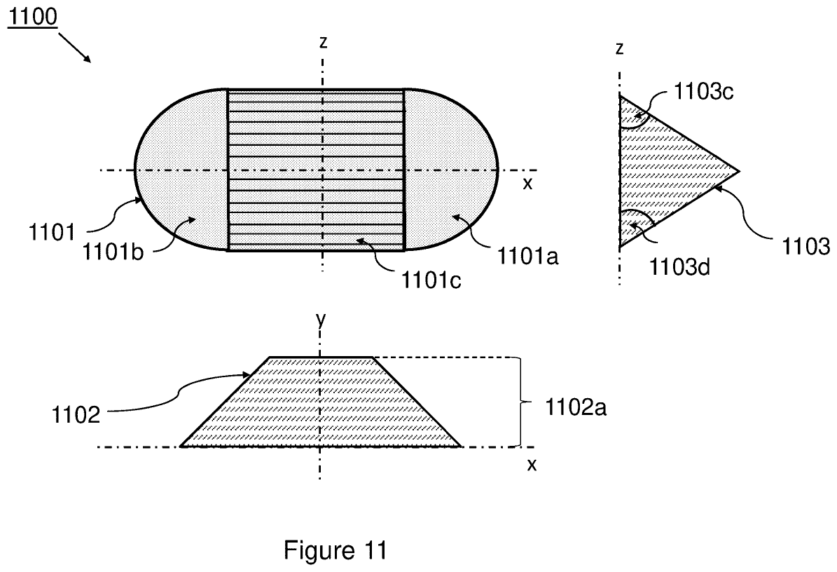

FIG. 11 illustrates the top (1101), front (1102), and side (1103) views of an extruded optical element (1100) of the current disclosure configured of two outer semi-axicons (1101a and 1101b) and a connecting element (1101c) with an axicon-like profile (1103) and a height (or apex) of 1102a as defined by the angles 1103c and 1103d and, wherein the axis of the connecting element (1101c) is centred along the x-axis.

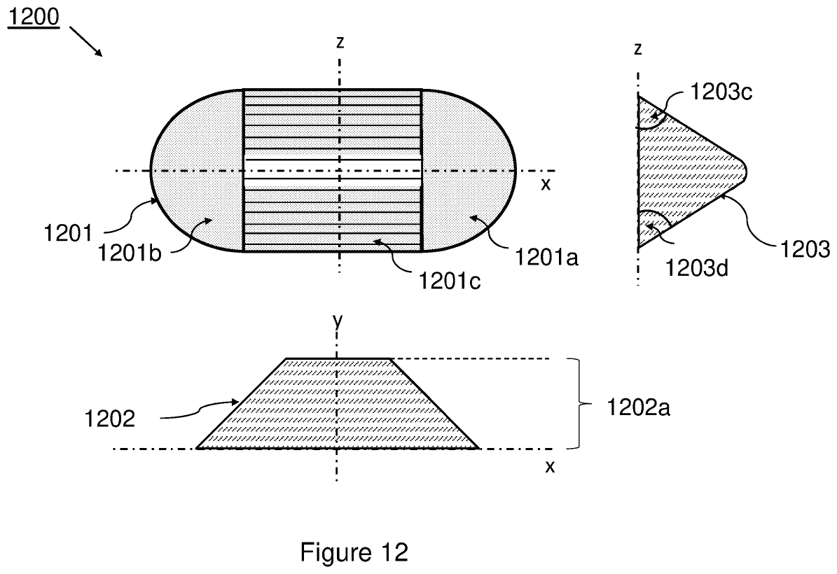

FIG. 12 illustrates the top (1201), front (1202), and side (1203) views of an extruded optical element (1200) of the current disclosure with two outer semi-lensacons (1201a and 1201b) and a connecting element (1201c) with a lensacon-like profile (1203) and a height (or apex) of 1202a as defined by the angles 1203c and 1203d and, wherein the axis of the connecting element (1201c) is centred along the x-axis.

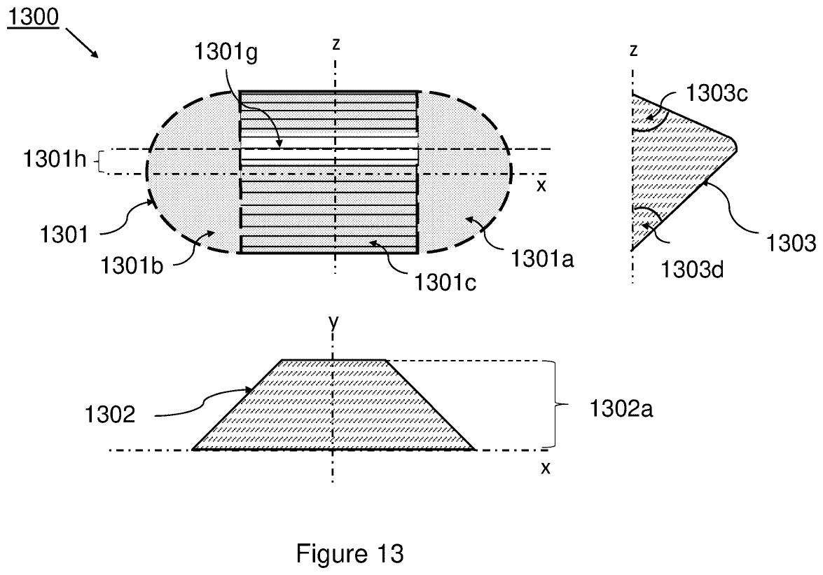

FIG. 13 illustrates the top (1301), front (1302), and side (1303) views of an extruded optical element (1300) of the current disclosure with two outer semi-axicons (1301a and 1301b) and a connecting element (1301c) with a tilted lensacon-like profile (1303) and a height (or apex) of 1302a as defined by the angles 1303c and 1303d and, wherein the axis (1301g) of the connecting element (1301c) is decentered by a distance of 1301h from the x-axis.

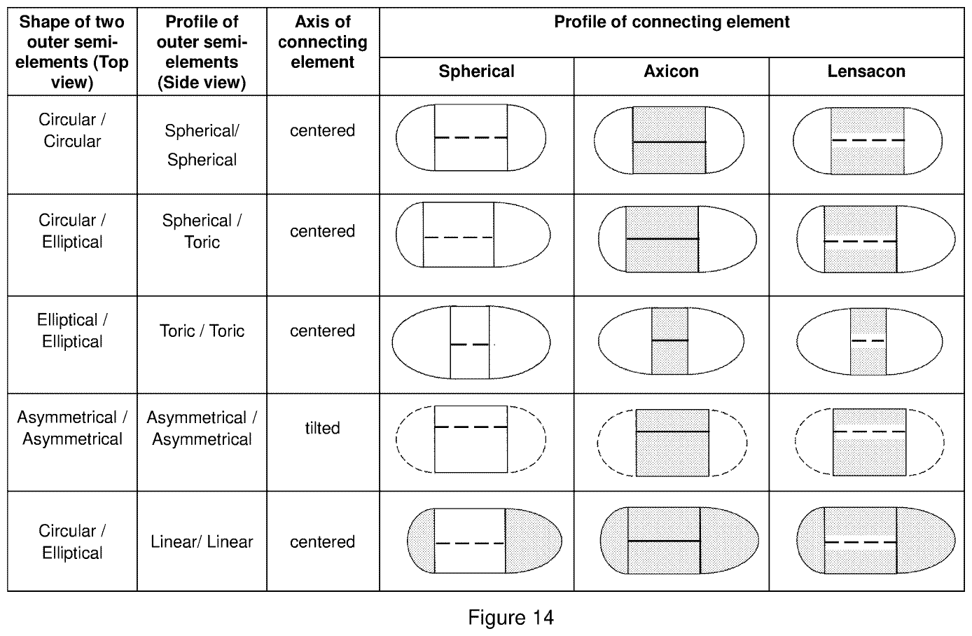

FIG. 14 shows the top views of various other combinations of extruded optical elements for use in exemplary myopia management spectacle lens embodiments of the current disclosure, wherein the outer semi-elements of the extruded optical elements are configured of different shapes and profiles, and the connecting elements of the extruded optical elements are configured of different profiles with the axes either being centred or tilted with respect to the bisecting x-axis of the connecting element. In other examples, the profiles of the two outer-semi elements and/or the connecting element may be axicon-like (e.g., logarithmic axicon) or fraxicons (i.e., hybrid element between a linear axicon and a logarithmic axicon).

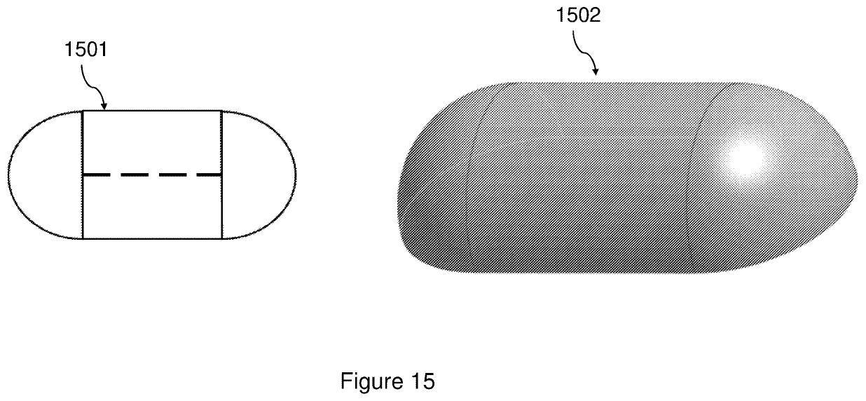

FIG. 15 illustrates the top view (1501) and a 3D image (1502) of an extruded optical element with two spherical outer semi-elements and a connecting element with spherical profile and centred axis, as described in FIGS. 9 and 14.

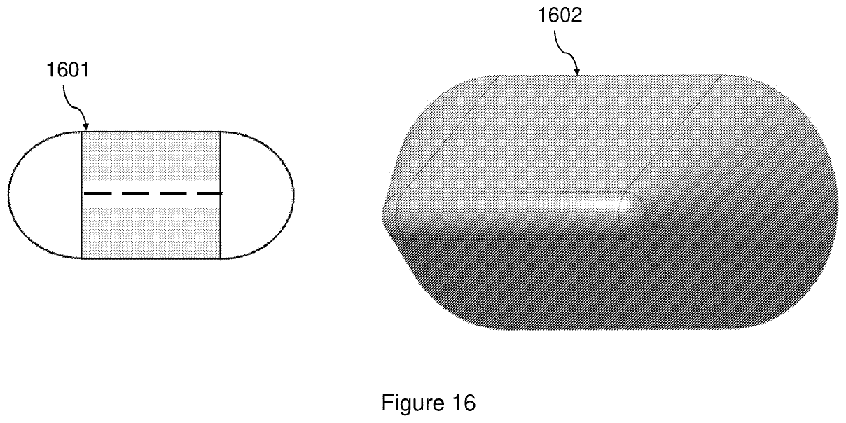

FIG. 16 illustrates the top view (1601) and a 3D image (1602) of an extruded optical element with two spherical outer semi-elements and a connecting element with a lensacon-like profile and centred axis, as described in FIG. 14.

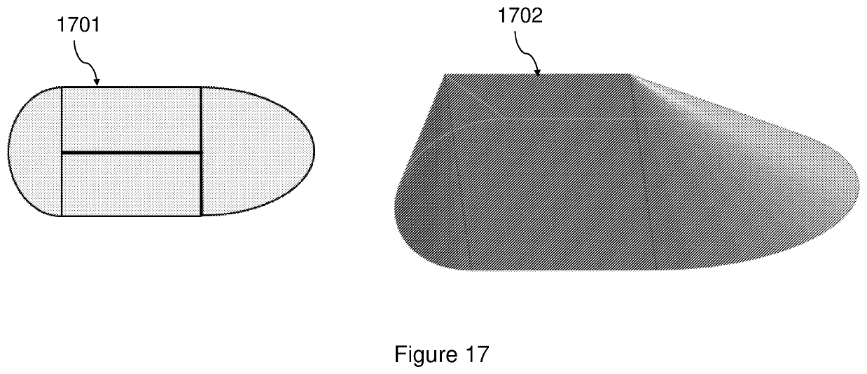

FIG. 17 illustrates the top view (1701) and a 3D image (1702) of an extruded optical element with two axicon-like outer semi-elements and a connecting element with an axicon-like profile and centred axis, as described in FIG. 14.

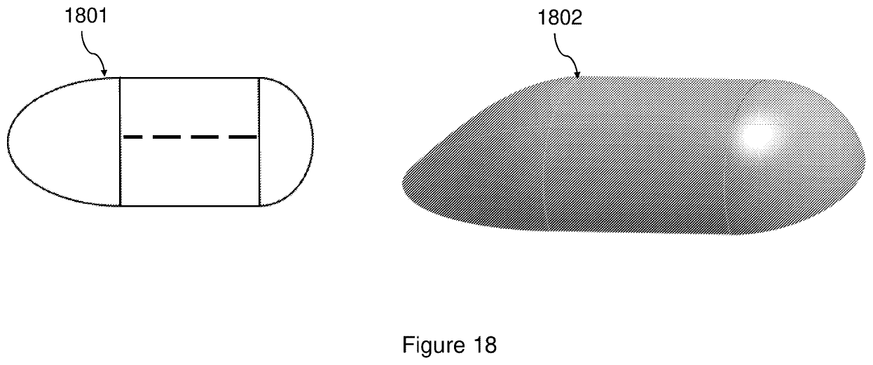

FIG. 18 illustrates the top view (1801) and a 3D image (1802) of an extruded optical element with a spherical outer semi-element, a toric outer semi-element and a connecting element with a spherical profile and centred axis, as described in FIG. 14.

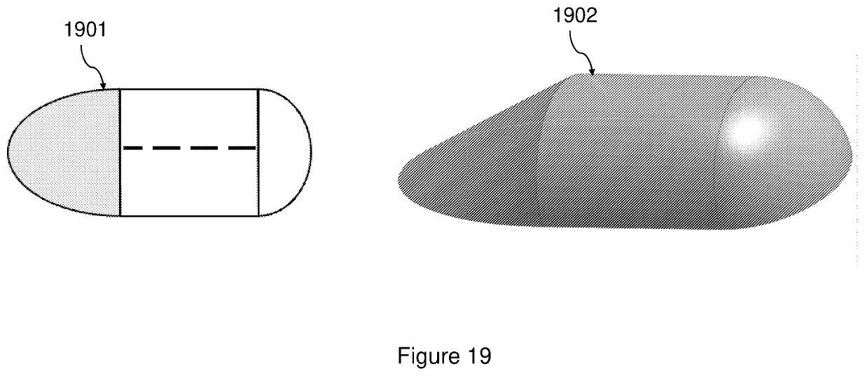

FIG. 19 illustrates the top view (1901) and a 3D image (1902) of an extruded optical element with a spherical outer semi-element, an axicon-like outer semi-element and a connecting element with a spherical profile and centred axis.

In other examples, the extruded optical element may have different combinations of shapes and/or profiles of the two out semi-elements, as well as different profiles with different amounts of tilt in the axis of the connecting element.

In the example power distribution 2101, the power of the two outer semi-elements (2101a and 2101b) remains constant across the azimuth, i.e., a spherical power distribution of about +1.5 DS for both outer semi-elements.

In the example power distribution 2102, the power of the two outer semi-elements (2101a and 2101b) changes across the azimuth, i.e., it follows a cosine function with normal frequency (i.e., two cosine cycles over) 360°. In this example the power of each toric outer semi-element is +0.5 DS/+1.5 DC.

In the example power distribution 2103, the power of the first outer semi-elements (2103a) changes across the azimuth (i.e., one cosine cycles over) 180°, representing a toric outer semi-element with a power of +0.5 DS/+1.5 DC. The power of the second outer semi-element (2103b) remains constant across the azimuth (i.e., between 180° and) 360° with a spherical power of +0.5 DS.

In the example power distribution 2104, the power of both outer semi-elements (2104a and 2104b) changes across the azimuth and is different between the two semi-elements. Wherein the power of the first outer semi-element (2104a) has a power of +0.5 DS with +0.75 D in Min-Max power, the power of the second outer semi-element (2104b) has a power of +1.25DS with +0.75 D in Min-Max power.

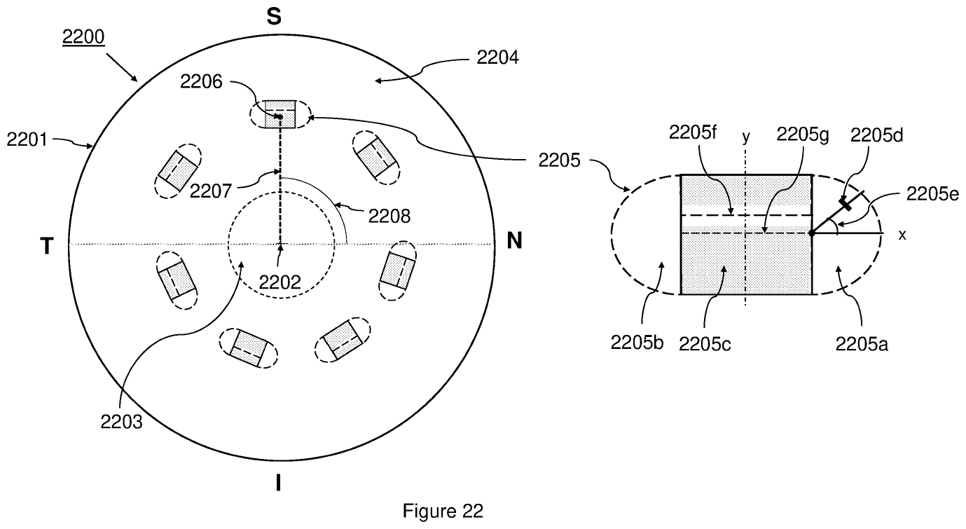

FIG. 22 illustrates the schematic diagram (left) of a myopia management spectacle lens embodiment (2200) of the present disclosure, wherein the optical zone (2201) is configured of a central distance zone (2203) with single vision correction and a peripheral treatment zone (2204) with extruded optical elements (2205) surrounded by areas with single vision correction. In this example the extruded optical elements (2205) are configured of two asymmetrical outer semi-elements with a lenscon-like connecting element, but in other examples they may be other extruded optical elements, such as described in FIG. 14. The location of each tilted extruded optical element (2205) within the myopia management spectacle lens embodiment is defined by a distance (2207) between the optical centre (2202) and the centre of the tilted extruded optical element (2206), i.e., the centre of the bisected connecting element along the y-axis, as well as by the azimuthal angle (2208).

FIG. 22 further illustrates a zoomed in version of the tilted extruded optical element (2205, right), comprising of two asymmetrical outer semi-elements (2205a and 2205b) and a connecting element (2205c), wherein the power distribution of each outer semi-element is defined by the radial distance (2205d) and the azimuthal angle (2205e). Further, the apex (2205f) of the connecting element (2205), i.e., the axis connecting the apices of the two outer semi-elements, is decentered with respect to the x-axis or primary line (2205g) bisecting the rectangular base of the connecting element (2205c). In other examples, where the extruded optical element is not tilted, the apex of the connecting element is in line with the x-axis or primary line bisecting the rectangular base of the connecting element.

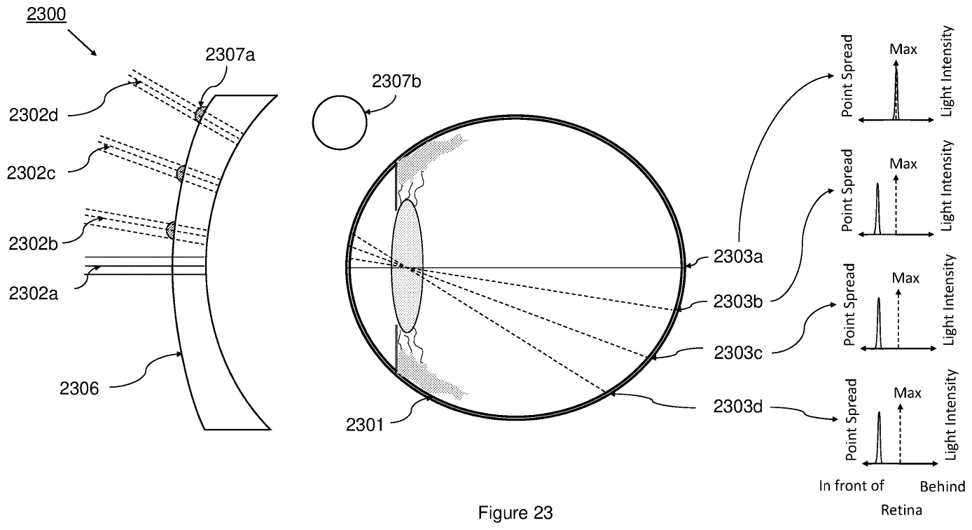

FIG. 23 illustrates a schematic diagram (2300, not to scale) of an on- and off-axis, TFRIS (2303 a-d), when the incoming light (0°, 2302a; 10°, 2302b; 20°, 2302c; 30°, 2303d), with a visible wavelength (e.g., 555 nm) and vergence of 0 D, depicting optical infinity, is incident on a myopic model eye (2301) (e.g., −2D) corrected with a lenslet based spectacle lens (2306) of prior art. The lenslet based spectacle lens (2306) of prior art has a clear central viewing zone devoid of lenslets and a peripheral treatment zone configured with positively powered spherical or aspherical lenslets (2307a). FIG. 23 shows that for incoming light at 0° (2302a) the rays focus on the retina, i.e., creating a peak in increased light intensity on the retina (2303a). Further, FIG. 23 shows that for incoming light at 10° (2302b), 20° (2302c) and 30° (2302d), i.e., where the lenslets (2307a) are located, the rays focus in front of the retina, i.e., creating a narrow TFRIS in front of the retina (2303 b-d).

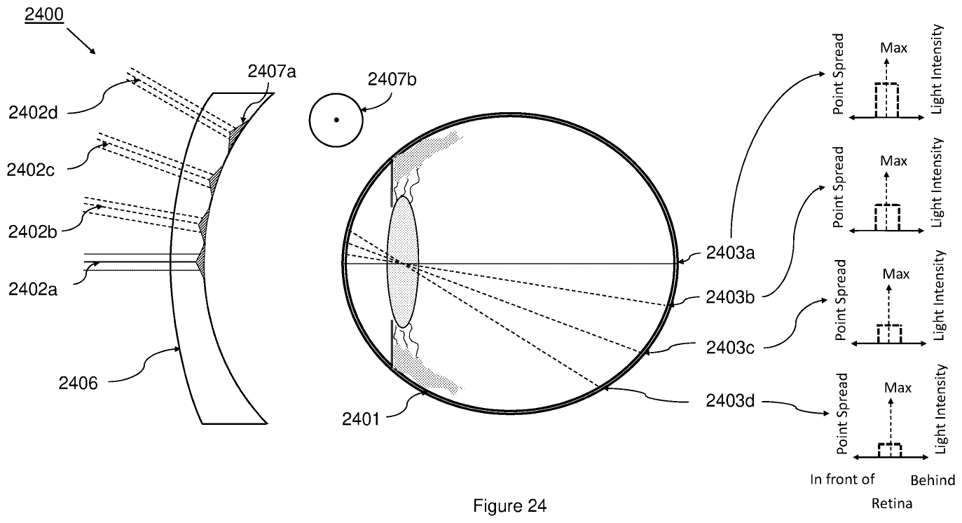

FIG. 24 illustrates a schematic diagram (2400, not to scale) of an on-axis and off-axis, TFRIS (2403 a-d), when the incoming light (0°, 2402a; 10°, 2402b; 20°, 2402c; 30°, 2403d), with a visible wavelength (e.g., 555 nm) and vergence of 0 D, depicting optical infinity, is incident on a myopic model eye (2401) (e.g., −2D) corrected with a myopia management spectacle lens (2406) with axicons (2407a and 2407b) as disclosed previously in WO 2021/159170. In this example, the myopia management spectacle lens (2406) is configured with axicons (2407a) that are located for incoming light at 0° (2402a), 10° (2402b), 20° (2402c) and 30° (2402d), which create an increase in the light intensity of the TFRIS (2403 a-d).

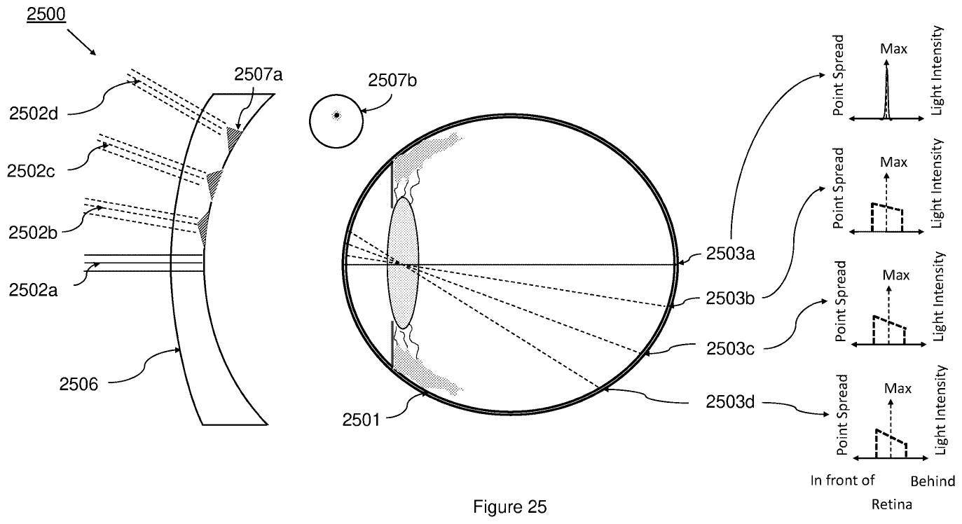

FIG. 25 illustrates a schematic diagram (2500, not to scale) of an on-axis and off-axis, TFRIS (2503 a-d), when the incoming light (0°, 2502a; 10°, 2502b; 20°, 2502c; 30°, 2503d), with a visible wavelength (e.g., 555 nm) and vergence of 0 D, depicting optical infinity, is incident on a myopic model eye (2501) (e.g., −2D) corrected with a myopia management spectacle lens embodiment (2506) of the current disclosure with tilted axicons (2507a and 2507b). In this example, the myopia management spectacle lens (2506) is configured with tilted axicons (2507a) that are located for incoming light 10° (2502b), 20° (2502c) and 30° (2502d). In other examples, the tilted optical elements may be tilted lensacons or tilted axicon-like elements (e.g., logarithmic axicons, fraxicons). In other examples, the location of the tilted optical elements may be for incoming light (i.e., visual field angles) ranging between 0° and 20°, 0° and 40°, 10° and 30°, 10° and 50° and 0° and 50°. When compared to the example embodiment of the previous disclosure (WO 2021/159170), the tilted axicons (2507a) create an increase in the light intensity of the TFRIS (2503 a-d). Further, in this example embodiment, the parameters of the tilted optical elements result in an increase of the light intensity of the TFRIS when compared to a spectacle lens as disclosed previously in WO 2021/159170 and/or wherein the parameters of the tilted optical elements result in a non-uniform light intensity of the TFRIS wherein the magnitude in light intensity is greater in front of the retina when compared to behind the retina.

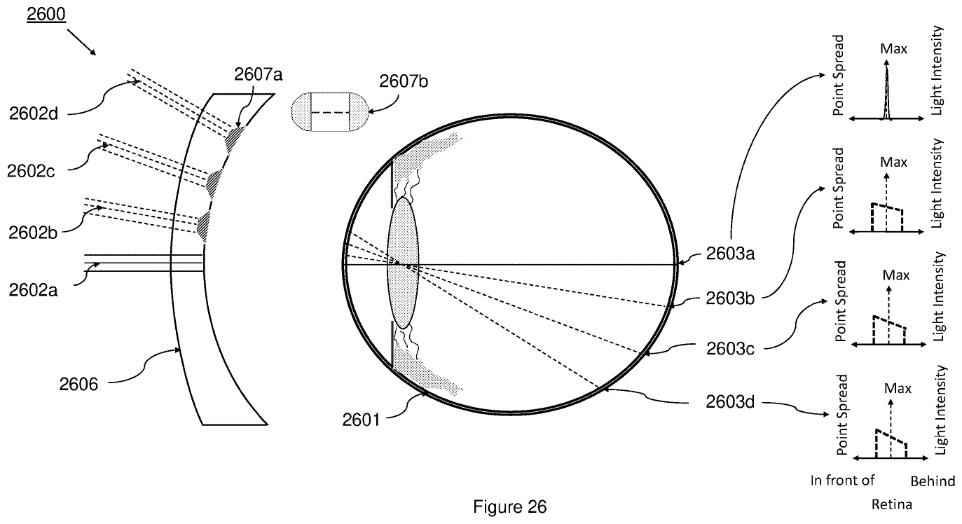

FIG. 26 illustrates a schematic diagram (2600, not to scale) of an on-axis and off-axis, TFRIS (2603 a-d), when the incoming light (0°, 2602a; 10°, 2602b; 20°, 2602c; 30°, 2603d), with a visible wavelength (e.g., 555 nm) and vergence of 0 D, depicting optical infinity, is incident on a myopic model eye (2601) (e.g., −2D) corrected with a myopia management spectacle lens embodiment (2606) of the current disclosure with extruded optical elements (2607a and 2607b). In this example, the myopia management spectacle lens (2606) is configured with extruded axicons (2607a) that are located for incoming light (i.e., visual field angles) at 10° (2602b), 20° (2602c) and 30° (2602d). In other examples, the extruded optical element may be configured of semi-elements or connecting elements with different profiles (e.g., lensacon-like, toric, asymmetrical). In other examples, the location of the tilted optical elements may be for incoming light ranging between 0° and 20°, 0° and 40°, 10° and 30°, 10° and 50° and 0° and 50°. When compared to the example embodiment of the previous disclosure (WO 2021/159170), the extruded axicons (2607a) create an increase of the light intensity of the TFRIS when compared to a spectacle lens as disclosed previously in WO 2021/159170 without the tilt. Further, the parameters of the tilted optical elements result in a non-uniform light intensity of the TFRIS wherein the magnitude in light intensity is greater in front of the retina when compared to behind the retina.

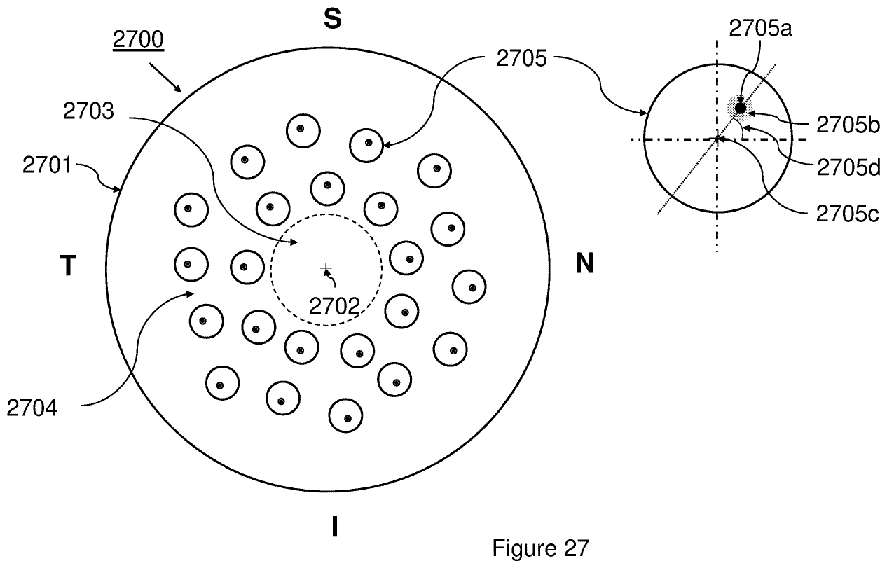

FIG. 27 illustrates a schematic diagram (left) of a myopia management spectacle lens embodiment of the present disclosure (2700, not to scale), wherein the optical zone (2701) with the optical centre (2702) is configured of a substantially circular central distance zone (2703) with single vision correction and a peripheral treatment zone (2704) with tilted lensacons (2705) surrounded by areas with single vision correction.

Further, FIG. 27 illustrates a zoomed in version of the tilted lensacon (2705, right), wherein the apex (2705a) with the curved lens top (2705b) is decentered from its geometrical centre (2705c) and wherein the direction of the tilted apex is further defined by the azimuthal angle (2705d).

The amount of tilt, the size of the area of the curved lens top, the size and height of the tilted lensacons, and the number and the locations of the tilted lensacons within the myopia management spectacle lens embodiment of the current disclosure may be optimised to increase the amount of the light intensity of the TFRIS at various visual field angles and increase in the light intensity in front of the retina. This increase in through-focus light intensity provides the desired optical signal to slow eye growth. In addition to providing a signal to slow eye growth, the myopia management spectacle lens embodiment permits foveal vision through the central distance zone as well as good peripheral vision through the surrounding distance vision areas of the peripheral treatment zone. The peripheral treatment zone can be optimised such that a balanced treatment and visual performance outcome can be achieved.

In other examples, the tilted optical elements may be tilted linear axicons, tilted logarithmic axicons, tilted fraxicons, tilted axilenses, or combinations of various titled optical elements. For example, in addition to the tilt, the curvature of the fraxicon or lensacon may be optimised as a function of visual field angle to permit an increase in through-focus light intensity with a peak in front of the retina.

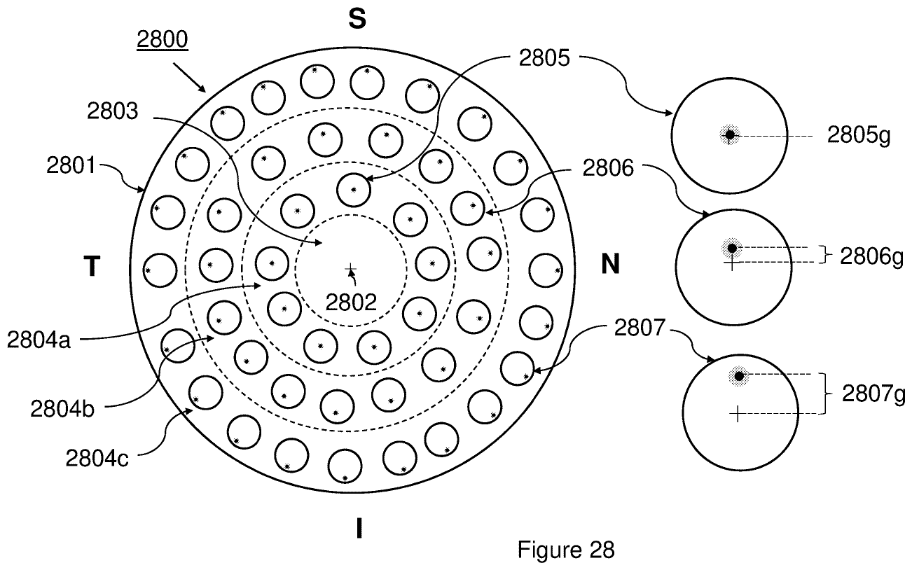

FIG. 28 illustrates a schematic diagram (left) of a myopia management spectacle lens embodiment of the present disclosure (2800, not to scale), wherein the optical zone (2801) with the optical centre (2802) is configured of a substantially circular central distance zone (2803) with single vision correction and three peripheral treatment zones (2804a, 2804b, 2804c) with centred (2805) and tilted (2806 and 2807) lensacons surrounded by areas with single vision correction. The lensacons (2805, 2806, 2807) in all three peripheral treatment zones (2804a, 2804b and 2804c) have curved lens tops of approximately the same size.

Further, FIG. 28 illustrates a zoomed in version of the centred and tilted lensacons (right) of the three peripheral treatment zones (2804a, 2804b and 2804c). Whilst the apex of the lensacon (2805) of the first peripheral treatment zone (2804a) is centred with respect to its geometrical centre (2805g), the apex of the tilted lensacon (2806) in the second peripheral treatment zone (2804b) is decentered from its geometrical centre (2806g) and the apex of the tilted lensacon (2807) in the third peripheral treatment zone is further decentered from its geometrical centre (2807g). In this example, the orientation of the apices of the tilted lensacons within the spectacle lens embodiment of the current disclosure was chosen to be in line with the azimuthal angle of the location of the geometrical centre of each tilted lensacon. The orientation of the apices of the lensacons as well as the change in tilt as a function of visual field can be optimised to provide an increase in the light intensity of the TFRIS at various visual field angles and increase in the light intensity in front of the retina. This increase in through-focus light intensity provides the desired optical signal to slow eye growth.

In other examples, the lensacons in the first peripheral treatment zone may also be tilted. In other examples, the number of treatment zones may be 1, 2, 4, 5 or 6. In other exemplary myopia management spectacle lens embodiments the orientation of the apices of the lensacons may not be in line with the azimuthal angle of the location of the geometrical centre of the lensacons. In other examples, the tilted optical elements may be tilted linear axicons, tilted logarithmic axicons, tilted, tilted axilenses, or combinations of various titled optical elements. For example, in addition to the tilt, the curvature of the fraxicon or the lensacon may be optimised as a function of visual field angle to permit an increase in through-focus light intensity with a peak in front of the retina.

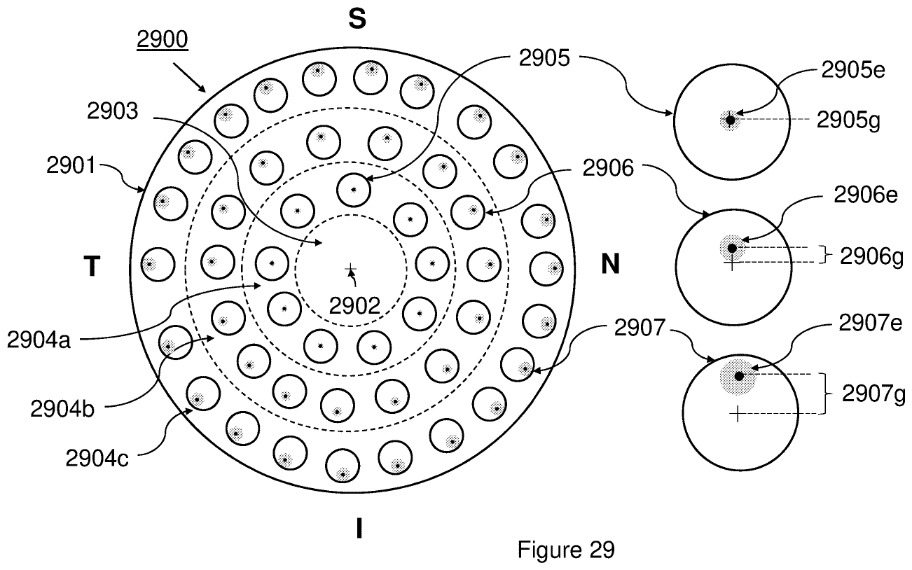

FIG. 29 illustrates a schematic diagram (left) of a myopia management spectacle lens embodiment of the present disclosure (2900, not to scale), wherein the optical zone (2901) with the optical centre (2902) is configured of a substantially circular central distance zone (2903) with single vision correction and three peripheral treatment zones (2904a, 2904b, 2904c) with centred (2905) and tilted (2906 and 2907) lensacons surrounded by areas with single vision correction. The lensacons (2905, 2906, 2907) have curved lens tops that increase with peripheral treatment zone, i.e., the greatest curved lens top is in the peripheral treatment zone 2904c.

Further, FIG. 29 illustrates a zoomed in version of the centred and tilted lensacons (right) of the three peripheral treatment zones (2904a, 2904b and 2904c). Whilst the apex of the lensacon (2905) of the first peripheral treatment zone (2904a) is centred with respect to its geometrical centre (2905g), the apex of the tilted lensacon (2906) in the second peripheral treatment zone (2904b) is decentered from its geometrical centre (2906g) and the apex of the tilted lensacon (2907) in the third peripheral treatment zone is further decentered from its geometrical centre (2907g). In addition to the decentration differences, the size of the curved lens top (2907e) of lensacon (2907) in the third peripheral treatment zone (2904c) is greater than the size of the curved lens top (2906e) of lensacon (2906) in the second peripheral treatment zone (2904b), which in turn is greater than the size of the curved lens top (2905e) of lensacon (2905) in the first peripheral treatment zone (2904a).

In this example, the orientation of the apices of the tilted lensacons within the myopia management spectacle lens embodiment of the current disclosure was chosen to be in line with the azimuthal angle of the location of the geometrical centre of the tilted lensacons. The increasing size of the curved lens tops as a function of peripheral treatment zone may provide benefits for visual performance and/or for ease of manufacture as the apex angle decreases toward the periphery. The orientation of the apices of the lensacons, the size of the curved lens tops as well as the change in tilt as a function of visual field can be optimised to provide an increase in the light intensity of the TFRIS at various visual field angles and increase in the light intensity in front of the retina. This increase in through-focus light intensity provides the desired optical signal to slow eye growth.

In other examples, the lensacons in the first peripheral treatment zone may also be tilted. In other examples, the number of treatment zones may be 1, 2, 4, 5 or 6. In other exemplary myopia management spectacle lens embodiments the orientation of the apices of the lensacons may not be in line with the azimuthal angle of the location of the geometrical centre of the lensacons.

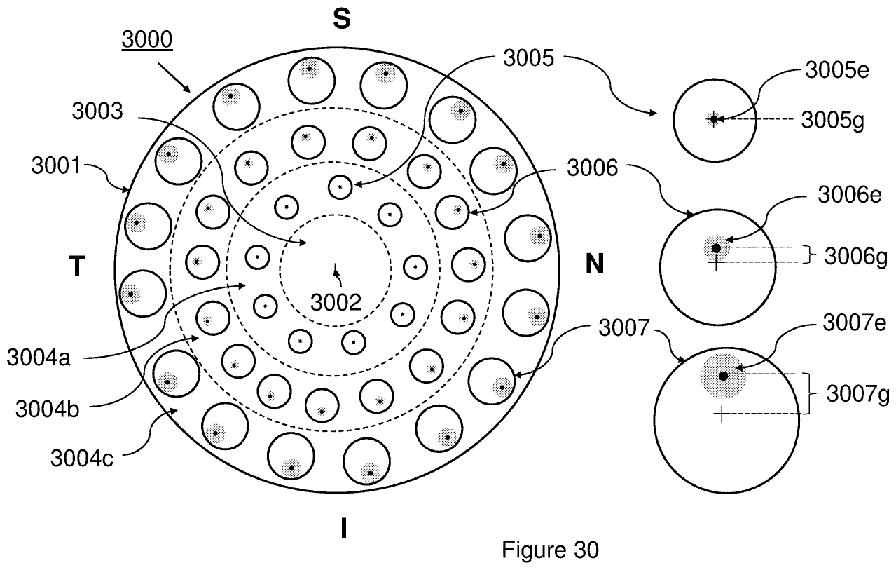

FIG. 30 illustrates a schematic diagram (left) of a myopia management spectacle lens embodiment of the present disclosure (3000, not to scale), wherein the optical zone (3001) with the optical centre (3002) is configured of a substantially circular central distance zone (3003) with single vision correction and three peripheral treatment zones (3004a, 3004b, 3004c) with centred (3005) and tilted (3006 and 3007) lensacons surrounded by areas with single vision correction. The lensacons (3005, 3006, 3007) have curved lens tops that increase with peripheral treatment zone, i.e., the greatest curved lens top is in the peripheral treatment zone 3004c. Further, the size of the lensacons (3005, 3006, 3007) increase with peripheral treatment zone, i.e., the greatest lensacon is in the peripheral treatment zone 3004c.

Further, FIG. 30 illustrates a zoomed in version of the centred and tilted lensacons (right) of the three peripheral treatment zones (3004a, 3004b and 3004c). Whilst the apex of the lensacon (3005) of the first peripheral treatment zone (3004a) is centred with respect to its geometrical centre (3005g), the apex of the tilted lensacon (3006) in the second peripheral treatment zone (3004b) is decentered from its geometrical centre (3006g) and the apex of the tilted lensacon (3007) in the third peripheral treatment zone is further decentered from its geometrical centre (3007g). In addition to the decentration differences, the size of the lensacon (3007) and the size of its curved lens top (3007e) in the third peripheral treatment zone (3004c) is greater than the size of the lensacon (3006) and the size of its curved lens top (2906e) in the second peripheral treatment zone (3004b), which in turn is greater than the size of the lensacon (3005) and its curved lens top (3005e) in the first peripheral treatment zone (3004a).

In this example, the orientation of the apices of the tilted lensacons within the myopia management spectacle lens embodiment of the current disclosure was chosen to be in line with the azimuthal angle of the location of the geometrical centre of the tilted lensacons. The increasing size of the lensacons and the size of the curved lens tops as a function of peripheral treatment zone may provide benefits for visual performance and/or for ease of manufacture as the apex angle decreases toward the periphery. The orientation of the apices of the lensacons, the size of the curved lens tops as well as the change in tilt as a function of visual field provides an increase in the light intensity of the TFRIS at various visual field angles and increase in the light intensity in front of the retina. This increase in through-focus light intensity provides the desired optical signal to slow eye growth.

In other examples, the lensacons in the first peripheral treatment zone may also be tilted. In other examples, the number of treatment zones may be 1, 2, 4, 5 or 6. In other exemplary myopia management spectacle lens embodiments the orientation of the apices of the lensacons may not be in line with the azimuthal angle of the location of the geometrical centre of the lensacons.

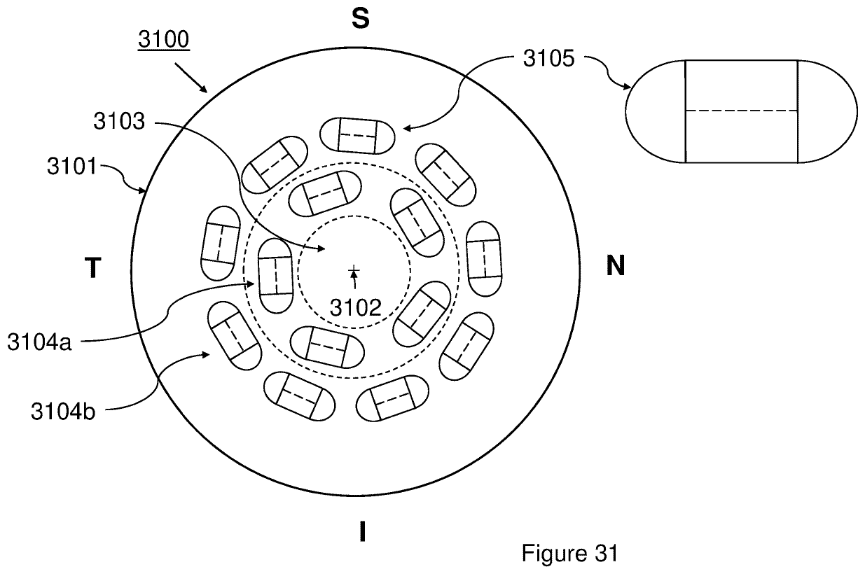

FIG. 31 illustrates a schematic diagram (left) of a myopia management spectacle lens embodiment of the present disclosure (3100, not to scale), wherein the optical zone (3101) with the optical centre (3102) is configured of a substantially circular central distance zone (3103) with single vision correction and two peripheral treatment zones (3104a and 3104b) with extruded optical elements (3105), wherein the area surrounding the extruded optical elements is configured with single vision correction. In this exemplary embodiment, the number of extruded optical elements (3105) in the first peripheral treatment zone (3104a) is five, and the number of extruded optical elements (3105) in the second peripheral treatment zone (3104b) is nine. In this example, the orientation of the apex, or apex line, of the connecting element of the extruded optical elements within the myopia management spectacle lens embodiment of the current disclosure was chosen to be approximately perpendicular to the optical centre (3102).

Further, FIG. 31 (right) shows a zoomed in version of the extruded optical element, which is configured of two spherical outer semi-elements and a connecting element with spherical profile and centred axis, as also shown in 3D in FIG. 15. In this example, the power of the two outer semi-elements is +1.5 DS and the extruded optical element is approximately 3 mm long and 1 mm wide.

In other examples, the orientation of the apex, or apex line, of the connecting element of the extruded optical elements may not be perpendicular to the optical centre. In other exemplary embodiments, the extruded optical element may be configured of toric, asymmetric, axicon-like, or lensacon-like outer semi-elements and/or the connecting element may have an axicon-like or lensacon-like profile either with a centred or tilted axis.

In other exemplary embodiments, the total number of extruded optical elements in the peripheral treatment zones may be 10, 15, 20, 25, 30 or 40. In other exemplary embodiments, the total number of extruded optical elements in the peripheral treatment zone may be at least 20.

In other examples of the current disclosure, the power of the two outer semi-elements may be +0.5DS, +1DS, +1.5DS, +2DS, +2.5DS, +3DS or +3.5DS. In other examples of the current disclosure, the power of the two outer semi-elements may be at least +0.75DS. In other examples of the current disclosure, the power of the two outer semi-elements of all extruded optical elements in the myopia management spectacle lens embodiment of the current disclosure may be between +0.5DS and +1.5DS, between +1DS and +3DS, or between +0.5DS and +3.5DS.

In other examples, the length of the extruded optical elements may be 1 mm, 2 mm, 3 mm, 4 mm or 5 mm and the width may be 0.5 mm, 1.5 mm, 2.5 mm, 3.5 mm, or 4.5 mm. In other examples, the length of the extruded optical elements may be between 1 mm and 3 mm, between 2 mm and 4 mm, between 1 mm or 5 mm and the width may be between 0.5 mm and 1.5 mm, between 1.5 mm and 3.5 mm or between 1 mm and 4.5 mm.

The orientation of the apex lines of the extruded optical elements, the choice of outer semi-elements, the choice of profile and axis centration of the connecting inner element, the number of treatment zones, the number and size of extruded optical elements and the power of the two outer semi-elements may be optimised as a function of visual field to provide an increase in the light intensity of the TFRIS at various visual field angles and increase in the light intensity in front of the retina. This increase in through-focus light intensity provides the desired optical signal to slow eye growth.

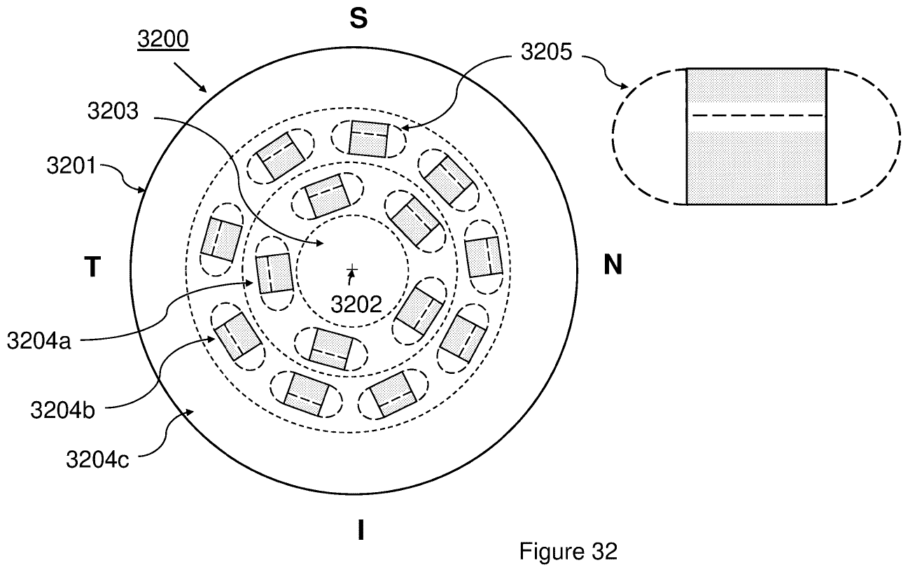

FIG. 32 illustrates a schematic diagram (left) of a myopia management spectacle lens embodiment of the present disclosure (3200, not to scale), wherein the optical zone (3201) with the optical centre (3202) is configured of a substantially circular central distance zone (3203) with single vision correction and two peripheral treatment zones (3204a and 3204b) with extruded optical elements (3205), wherein the area surrounding the extruded optical elements is configured with single vision correction. In this exemplary embodiment, the number of extruded optical elements (3205) in the first peripheral treatment zone (3204a) is five, and the number of extruded optical elements (3205) in the second peripheral treatment zone (3204b) is nine. In this example, the orientation of the apex, or apex line, of the connecting element of the extruded optical elements within the spectacle lens embodiment of the current disclosure was chosen to be approximately perpendicular to the optical centre (3202).

Further, FIG. 32 (right) shows a zoomed in version of the extruded optical element, which is configured of two asymmetrical outer semi-elements and a connecting element with lensacon-like profile and tilted axis. In this example, the Min-Max power of the two outer semi-elements is +1.75 D and the extruded optical element is approximately 3 mm long and 1 mm wide.

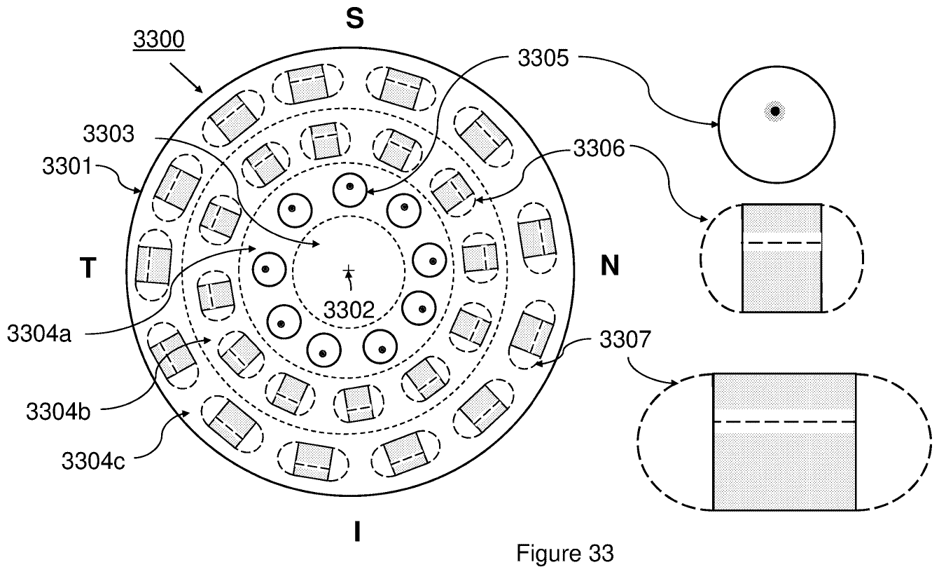

FIG. 33 illustrates a schematic diagram (left) of a myopia management spectacle lens embodiment of the present disclosure (3300, not to scale), wherein the optical zone (3301) with the optical centre (3302) is configured of a substantially circular central distance zone (3303) with single vision correction and three peripheral treatment zones (3304a, 3304b and 3304c) with tilted lensacons (3305) and extruded optical elements (3306 and 3307), wherein the area surrounding the tilted lensacons and extruded optical elements is configured with single vision correction. In this exemplary embodiment, the number of tilted lensacons (3305) in the first peripheral treatment zone (3304a) is nine, the number of extruded optical elements (3306) in the second peripheral treatment zone (3304b) is 12, and the number of extruded optical elements (3307) in the third peripheral treatment zone (3304c) is 13. The orientation of the apices of the tilted lensacons (3305) within the first peripheral treatment zone (3304a) was chosen to be approximately in line with the azimuthal angle of the location of the geometrical centre of lensacons, and the orientation of the apices, or apex lines, of the connecting elements of the extruded optical elements within the second (3304b) and third (3304c) peripheral treatment zone was chosen to be approximately perpendicular to the optical centre (3302).

Further, FIG. 33 (right) shows a zoomed in version of the tilted lensacon (3305) and the two extruded optical elements (3306 and 3307) of the first (3304a), second (3304b) and third (3304c) peripheral treatment zones, wherein the extruded optical elements (3306 and 3307) are configured of two asymmetrical outer semi-elements and a connecting element with lensacon-like profile and tilted axis. In this example, the Min-Max power of the two outer semi-elements of the extruded optical element (3306) in the peripheral treatment zone (3304b) is +1.5 D and the extruded optical element (3306) is approximately 2 mm long and 0.5 mm wide. Further, the Min-Max power of the two outer semi-elements of the extruded optical element (3307) in the peripheral treatment zone (3304c) is +2.5 D and the extruded optical element (3307) is approximately 3 mm long and 1 mm wide.

In other examples, the orientation of the apices of the tilted lensacons of the first peripheral treatment zone may not be in line with the azimuthal angle of the location of the geometrical centre of tilted lensacons and the orientation of the apices, or apex lines, of the connecting element of the extruded optical elements in the second and third peripheral treatment zones may not be perpendicular to the optical centre of the myopia management spectacle lens embodiment.

In other examples, the tilted optical elements in the first peripheral treatment zone may be tilted or centred linear axicons, tilted or centred logarithmic axicons, tilted or centred fraxicons, tilted or centred axilenses, or combinations of various optical elements. The tilted optical elements may also be configured in the second and/or third peripheral treatment zone, instead of the first.

In other exemplary embodiments, the extruded optical elements in the second and third peripheral treatment zones may be configured of spherical, toric, asymmetrical, axicon-like or lensacon-like outer semi-elements and/or the connecting elements may have a spherical or axicon-like profile either with a centred or tilted axis or may be combinations of various extruded optical elements. The extruded optical elements may also be configured in the first and second peripheral treatment zones or the first and third peripheral treatment zones. In other examples of the myopia management spectacle lens embodiment of the current disclosure, the optical elements within each peripheral treatment zone may be tilted and/or centred optical elements and may be tilted and/or centred extruded optical elements or combinations thereof.

The orientation of the apex lines of the extruded optical elements, the choice of outer semi-elements, the choice of profile and axis centration of the connecting inner element, the number of treatment zones, the number and size of extruded optical elements and the Min-Max power of the two outer semi-elements may be optimised as a function of visual field to provide an increase in the light intensity of the TFRIS at various visual field angles and increase in the light intensity in front of the retina. This increase in through-focus light intensity provides the desired optical signal to slow eye growth.

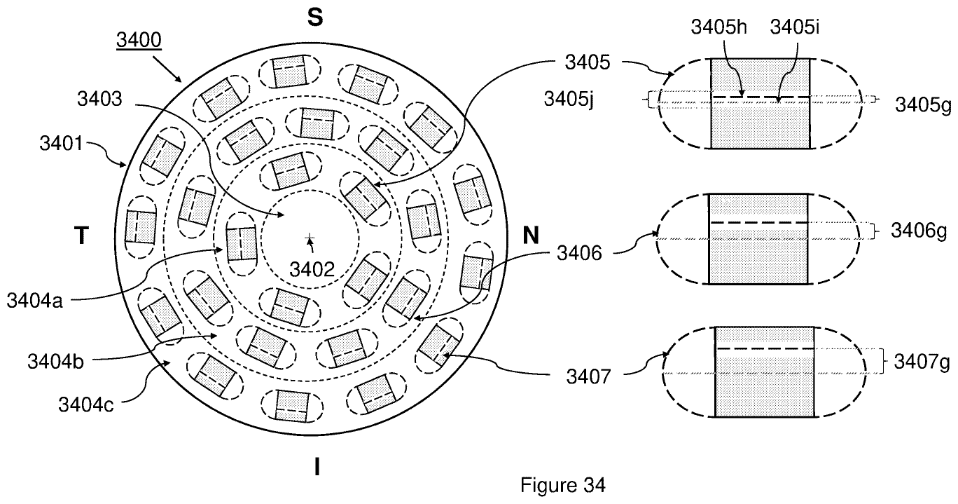

FIG. 34 illustrates a schematic diagram (left) of a myopia management spectacle lens embodiment of the present disclosure (3400, not to scale), wherein the optical zone (3401) with the optical centre (3402) is configured of a substantially circular central distance zone (3403) with single vision correction and three peripheral treatment zones (3404a, 3404b and 3404c) with extruded optical elements (3405, 3406 and 3407), wherein the area surrounding the extruded optical elements is configured with single vision correction. In this exemplary embodiment, the number of extruded optical elements (3405) in the first peripheral treatment zone (3404a) is five, the number of extruded optical elements (3406) in the second peripheral treatment zone (3404b) is nine, and the number of extruded optical elements (3407) in the third peripheral treatment zone (3404c) is 13. The orientation of the apices, or apex lines, of the connecting elements of the extruded optical elements within the three peripheral treatment zones (3404a, 3404b and 3404c) was chosen to be approximately perpendicular to the optical centre (3402). The amount of tilt for the extruded optical elements (3405, 3406 and 3407) varies between the three peripheral treatment zones (3404a, 3404b and 3404c). In the example for the extruded optical element (3405), the amount of tilt, is defined as the amount of decentration between the axis of the apex (or apex line) (3405h), and the axis (or bisecting line) of the connecting element (3405i). In FIG. 34, the decentration (3405g) of the extruded optical elements (3405) in the first peripheral treatment zone (3404a) is 0.1 mm, the decentration (3406g) of the extruded optical elements (3406) in the second peripheral treatment zone (3404b) is 0.2 mm and the decentration (3407g) of the extruded optical elements (3407) in the third peripheral treatment zone (3404c) is 0.3 mm. Increasing the decentration toward the periphery of the spectacle lens embodiment may be beneficial for the increase in the light intensity of the TFRIS at various visual field angles.

Further, FIG. 34 (right) shows a zoomed in version of the three extruded optical elements (3405, 3406 and 3407) of the first (3404a), second (3404b) and third (3404c) peripheral treatment zones, wherein the extruded optical elements (3405, 3406 and 3407) are configured of two asymmetrical outer semi-elements and a connecting element with lensacon-like profile and tilted axis. In this example, the Min-Max power of the two outer semi-elements of the extruded optical elements (3405, 3406 and 3407) is +1.5 D and the extruded optical elements (3405, 3406 and 3407) are approximately 3 mm long and 1 mm wide. The lensacon-like profile of the connecting element of the extruded optical element (3405) has a curved top (as indicated by the white zone) with a width (3405j). The width of the curved top is substantially the same for all extruded optical elements (3405, 3406 and 3407) within all three peripheral treatment zones (3404a, 3404b and 3404c).

The orientation of the apex lines of the extruded optical elements, the choice of outer semi-elements, the choice of profile and axis centration of the connecting inner element, the number of treatment zones, the number and size of extruded optical elements, and the Min-Max power of the two outer semi-elements may be optimised as a function of visual field to provide an increase in the light intensity of the TFRIS at various visual field angles and increase in the light intensity in front of the retina. This increase in through-focus light intensity provides the desired optical signal to slow eye growth.

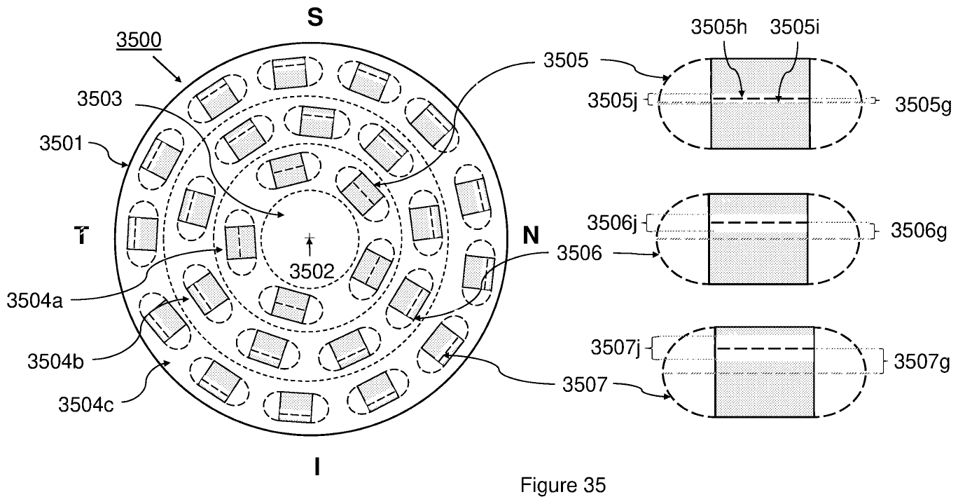

FIG. 35 illustrates a schematic diagram (left) of a myopia management spectacle lens embodiment of the present disclosure (3500, not to scale), wherein the optical zone (3501) with the optical centre (3502) is configured of a substantially circular central distance zone (3503) with single vision correction and three peripheral treatment zones (3504a, 3504b and 3504c) with extruded optical elements (3505, 3506 and 3507), wherein the area surrounding the extruded optical elements is configured with single vision correction. In this exemplary embodiment, the number of extruded optical elements (3505) in the first peripheral treatment zone (3504a) is five, the number of extruded optical elements (3506) in the second peripheral treatment zone (3504b) is nine, and the number of extruded optical elements (3507) in the third peripheral treatment zone (3504c) is 13. The orientation of the apices, or apex lines, of the connecting elements of the extruded optical elements within the three peripheral treatment zones (3504a, 3504b and 3504c) was chosen to be approximately perpendicular to the optical centre (3502). The amount of tilt for the extruded optical elements (3505, 3506 and 3507) varies between the three peripheral treatment zones (3504a, 3504b and 3504c). In the example for the extruded optical element (3505), the amount of tilt, is defined as the amount of decentration between the axis of the apex (or apex line) (3505h), and the axis (or bisecting line) of the connecting element (3505i). In this example, the decentration (3505g) of the extruded optical elements (3505) in the first peripheral treatment zone (3504a) is 0.1 mm, the decentration (3506g) of the extruded optical elements (3506) in the second peripheral treatment zone (3504b) is 0.2 mm and the decentration (3507g) of the extruded optical elements (3507) in the third peripheral treatment zone (3504c) is 0.3 mm. The increasing decentration, or tilt, toward the periphery of the spectacle lens embodiment may be beneficial for the increase in the light intensity of the TFRIS at various visual field angles.

Further, FIG. 35 (right) shows a zoomed in version of the three extruded optical elements (3505, 3506 and 3507) of the first (3504a), second (3504b) and third (3504c) peripheral treatment zones, wherein the extruded optical elements are configured of two asymmetrical outer semi-elements and a connecting element with lensacon-like profile and tilted axis. In this example, the Min-Max power of the two outer semi-elements of the extruded optical elements (3505, 3406 and 3407) is +1.5 D and the extruded optical elements (3505, 3506 and 3507) are approximately 3 mm long and 1 mm wide. The lensacon-like profiles of the connecting element of the extruded optical elements (3505, 3506 and 3507) have a curved top (as indicated by the white zones) with a width (3505j, 3506j and 3507j), which increases toward the periphery, i.e., from the first to the second and to the third peripheral treatment zone. The increasing widths of the curved lensacon-like tops (or apex lines) toward the periphery of the myopia management spectacle lens embodiment may be beneficial for the increase in the light intensity of the TFRIS at various visual field angles and/or may be beneficial for the manufacture of the more tilted peripheral extruded optical elements.

The orientation of the apex lines of the extruded optical elements, the choice of outer semi-elements, the choice of profile and axis centration (or tilt) of the connecting inner element, the number of treatment zones, the number and size of extruded optical elements, and the Min-Max power of the two outer semi-elements may be optimised as a function of visual field to provide an increase in the light intensity of the TFRIS at various visual field angles and increase in the light intensity in front of the retina. This increase in through-focus light intensity provides the desired optical signal to slow eye growth.

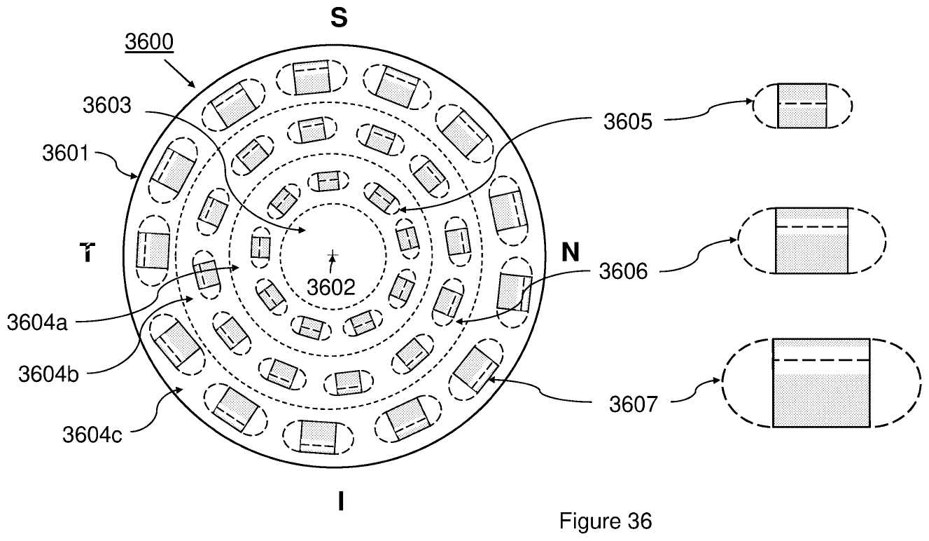

FIG. 36 illustrates a schematic diagram (left) of a myopia management spectacle lens embodiment of the present disclosure (3600, not to scale), wherein the optical zone (3601) with the optical centre (3602) is configured of a substantially circular central distance zone (3603) with single vision correction and three peripheral treatment zones (3604a, 3604b and 3604c) with extruded optical elements (3605, 3606 and 3607), wherein the area surrounding the extruded optical elements is configured with single vision correction. In this exemplary embodiment, the number of extruded optical elements (3605) in the first peripheral treatment zone (3604a) is nine, the number of extruded optical elements (3606) in the second peripheral treatment zone (3504b) is 12, and the number of extruded optical elements (3607) in the third peripheral treatment zone (3604c) is 13. The orientation of the apices, or apex lines, of the connecting elements of the extruded optical elements within the three peripheral treatment zones (3604a, 3604b and 3604c) was chosen to be approximately perpendicular to the optical centre (3602). The amount of tilt for the extruded optical elements (3605, 3606 and 3607) varies between the three peripheral treatment zones (3604a, 3604b and 3604c), wherein the tilt increases toward the periphery of the myopia management spectacle lens embodiment. Increasing the decentration, or tilt, toward the periphery of the myopia management spectacle lens embodiment may be beneficial for the increase in the light intensity of the TFRIS at various visual field angles.

Further, FIG. 36 (right) shows a zoomed in version of the three extruded optical elements (3605, 3606 and 3607) of the first (3604a), second (3604b) and third (3604c) peripheral treatment zones, wherein the extruded optical elements are configured of two asymmetrical outer semi-elements and a connecting element with lensacon-like profile and tilted axis. In this example, the Min-Max power of the two outer semi-elements of the extruded optical elements (3605) is +1 D and the extruded optical elements (3605) are approximately 1 mm long and 0.5 mm wide. The Min-Max power of the two outer semi-elements of the extruded optical elements (3606) is +1.75 D and the extruded optical elements (3605) are approximately 2 mm long and 1.5 mm wide. The Min-Max power of the two outer semi-elements of the extruded optical elements (3607) is +2.5 D and the extruded optical elements (3607) are approximately 3 mm long and 1 mm wide. The lensacon-like profiles of the connecting element of the extruded optical elements (3605, 3606 and 3607) have a curved top (as indicated by the white zones), which increases toward the periphery, i.e., from the first to the second and to the third peripheral treatment zone. The increasing widths of the curved lensacon-like tops (or apex lines) toward the periphery of the myopia management spectacle lens embodiment may be beneficial for the increase in the light intensity of the TFRIS at various visual field angles and/or may be beneficial for the manufacture of the more tilted peripheral extruded optical elements.

The orientation of the apex lines of the extruded optical elements, the choice of outer semi-elements, the choice of profile and axis centration (or tilt) of the connecting inner element, the number of treatment zones, the number and size of extruded optical elements, and the Min-Max power of the two outer semi-elements may be optimised as a function of visual field to provide an increase in the light intensity of the TFRIS at various visual field angles and increase in the light intensity in front of the retina. This increase in through-focus light intensity provides the desired optical signal to slow eye growth.

In other similar examples to FIGS. 34 to 36, the orientation of the apices, or apex lines, of the connecting element of the extruded optical elements may not be perpendicular to the optical centre. In other exemplary embodiments, the extruded optical elements may be configured of combinations of spherical, toric, axicon-like, fraxicon-like or lensacon-like outer semi-elements and/or the connecting elements may have a spherical or lensacon-like profile with centred or tilted axis or may be combinations of various extruded optical elements. In other examples, the amount of tilt of the extruded optical elements within each peripheral treatment zone may be smaller or larger. The extruded optical elements may also be configured in more than one defined peripheral treatment zone. In other examples, the number of treatment zones may be 1, 2, 4, 5 or 6.

In other similar examples to FIGS. 34 to 36, the total number of extruded optical elements in the peripheral treatment zones may be 10, 15, 20, 25, 30, 40 or 60. In other exemplary embodiments, the total number of extruded optical elements in the peripheral treatment zones may be at least 20.

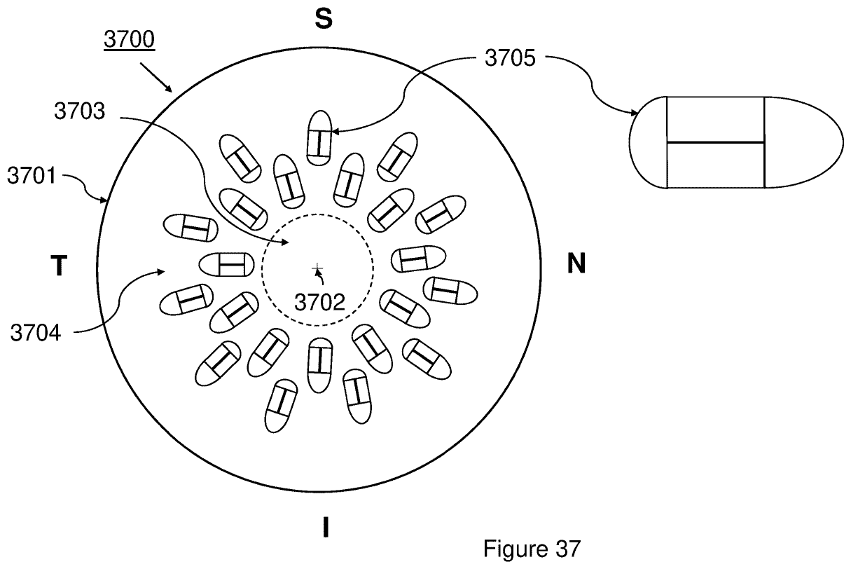

FIG. 37 illustrates a schematic diagram (left) of a myopia management spectacle lens embodiment of the present disclosure (3700, not to scale), wherein the optical zone (3701) with the optical centre (3702) is configured of a substantially circular central distance zone (3703) with single vision correction and a peripheral treatment zone (3704) with extruded optical elements (3705), wherein the area surrounding the extruded optical elements is configured with single vision correction. In this exemplary embodiment, the total number of extruded optical elements (3705) is 22. The orientation of the apices, or apex lines, of the connecting elements of the extruded optical elements was chosen to be approximately in line with the optical centre (3702).

Further, FIG. 37 (right) shows a zoomed in version of the extruded optical elements (3705) of the peripheral treatment zone, wherein the extruded optical elements are configured of one spherical and one toric outer semi-element and a connecting element with axicon-like profile and centered axis. In this example, the Sphere power of the spherical outer semi-elements of the extruded optical elements (3705) is +1.5 DS and the Cylinder power of the toric outer semi-element is +1.5 DS/+0.5 DC and the extruded optical elements (3705) are approximately 3.5 mm long and 1 mm wide. The peripheral location of the toric outer semi-elements relative to the spherical outer semi-elements may be beneficial for the increase in the light intensity of the TFRIS at various visual field angles.

In other similar examples to FIGS. 37, the orientation of the apices, or apex lines, of the connecting element of the extruded optical elements may not be in line with the optical centre. In other exemplary embodiments, the extruded optical elements may be configured of combinations of spherical, toric, axicon-like, fraxicon-like or lensacon-like outer semi-elements and/or the connecting elements may have a spherical or lensacon-like profile with centred or tilted axis or may be combinations of various extruded optical elements. In other examples, the amount of tilt of the extruded optical elements within each peripheral treatment zone may be smaller or larger. The extruded optical elements may also be configured in more than one defined peripheral treatment zone. In other examples, the number of treatment zones may be 2, 3, 4, 5 or 6.

In other similar examples, the total number of extruded optical elements in the peripheral treatment zones may be 10, 15, 20, 25, 30, 40 or 60. In other exemplary embodiments, the total number of extruded optical elements in the peripheral treatment zones may be at least 20.

In other examples of the current disclosure utilising extruded optical elements, the Min-Max power of the two outer semi-elements of the extruded optical elements may be +0.5 D, +1 D, +1.5 D, +2 D, +2.5 D, +3 D or +3.5 D. In other examples of the current disclosure, the Min-Max power of the two outer semi-elements of the extruded optical elements may be at least +0.75 D. In other examples of the current disclosure, the Min-Max power of the two outer semi-elements of all extruded optical elements in the spectacle lens embodiment of the current disclosure may be between +0.5 D and +1.5 D, between +1 D and +3 D, or between +0.5 D and +3.5 D.

In other examples, the length of the extruded optical elements may be 1 mm, 2 mm, 3 mm, 4 mm or 5 mm and the width may be 0.5 mm, 1.5 mm, 2.5 mm, 3.5 mm, or 4.5 mm. In other examples, the length of the extruded optical elements may be between 1 mm and 3 mm, between 2 mm and 4 mm, between 1 mm or 5 mm and the width may be between 0.5 mm and 1.5 mm, between 1.5 mm and 3.5 mm or between 1 mm and 4.5 mm.

Certain embodiments of the present disclosure are directed to myopia management spectacle lenses that may provide an increase in light intensity of the TFRIS at various visual field angles.

In some embodiments the contemplated or selected partial area of the treatment zone configured with optical elements of the current disclosure may be 25%, 30%, 35%, 50%, 60%, or 75% of the total area of the optic zone. In some other embodiments the contemplated or selected partial area of the treatment zone configured with optical elements of the current disclosure may be between 20% and 30%, 30% and 50%, 15% and 45% of the total area of the of the optic zone.

In certain embodiments, a substantial portion of the optical zone of the spectacle lens made up with optical elements may be understood to mean between 10% and 30%, between 30% and 50%, between 20% and 40% or between 10% and 40% of the optical zone of the spectacle lens.

In some embodiments, the tilted optical elements and/or the extruded optical elements with or without tilt, of the current disclosure may be located, formed, or placed on the front surface, back surface, or combinations thereof.

In certain other embodiments, the part of the myopia management spectacle lens comprising the tilted optical elements and/or the extruded optical elements with or without tilt may be located, formed, or placed on one of the two surfaces of the myopia management spectacle lens and the other surface may have other features for further reducing eye growth. For example, use of additional features like defocus, coma, or spherical aberration. In some examples, the power of the area surrounding the optical elements in the at least one peripheral treatment zone may be at least 0.25 D, 0.5 D, 1 D, 1.5 D more positive than the central distance zone.

A schematic model eye (Table 1) was chosen to demonstrate the differences in the through-focus MTF between a lens with optical elements as previously disclosed in WO 2021/159170 and a myopia management spectacle lens of the current disclosure.

The prescription parameters of the schematic model eye used for optical modelling and simulation of the performance are tabulated in Table 1. However, in other exemplary embodiments, schematic raytracing model eyes like Liou-Brennan, Escudero-Navarro and others may be used instead of the above simple model eye. One may also alter the parameters of the cornea, lens, retina, ocular media, or combinations thereof, to aid further simulation of the embodiments disclosed herein.

The examples provided herein have used a −3 D myopic model eye to disclose the present invention, however, the same disclosure can be extended to other degrees of myopia, for example, −1 D, −2 D, −5 D or −6 D. Further, it is understood that the scope of the invention can be extended to eyes with varying degrees of myopic refractive error, with or without astigmatism.

The prescription offers a −3 D myopic eye defined for a monochromatic wavelength of 589 nm. The prescription described in Table 1 should not be construed as an imperative method to demonstrate the effect of the contemplated exemplary embodiment. It is just one of many methods that may be used by the person skilled in the art for optical simulation purposes.

TABLE 1
Prescription of a schematic model eye
that offers a −3 D myopic model eye.

| | | Thick- | Refractive | Semi | Conic |
|---|---|---|---|---|---|
| Description | Radius | ness | Index | Diameter | Constant |
| | Infinity | Infinity | | 0.00 | 0.000 |
| Start | Infinity | 13.000 | | 4.00 | 0.000 |
| Anterior Cornea | 7.750 | 0.550 | 1.376 | 5.750 | −0.250 |
| Posterior Cornea | 6.400 | 3.000 | 1.334 | 5.50 | −0.400 |
| Pupil | Infinity | 0.450 | 1.334 | 5.00 | 0.000 |
| Anterior Lens | 10.800 | 3.800 | 1.423 | 4.50 | −4.798 |
| Posterior Lens | −6.250 | 17.721 | 1.334 | 4.50 | −4.101 |
| Retina | −12.00 | 0.000 | | 10.00 | 0.000 |

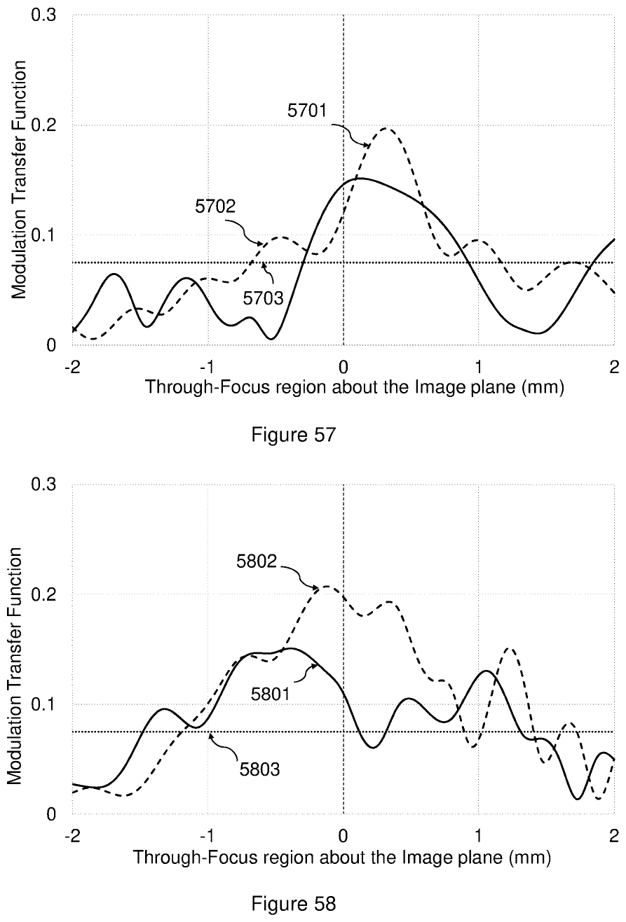

For the optical modelling of the MTF, the −3 D myopic eye (Table 1) was corrected with a spectacle lens configured of a front and a back surface, wherein the radius (curvature) of the front surface was 250 mm and the radius of the back surface was 106.5 mm. The lens had a refractive index of 1.59, an Abbe number of 64.2 and a thickness of 1.5 mm. For all MTF analysis the conic constant was set to 0 for the front and back surfaces of the spectacle lens, except for the MTF modelling of FIG. 57, where the conic constant was set to −40. In other embodiments, a more appropriate conic constant may be used to move the MTF behind or in front of the retina, for example, a conic constant between −50 and 50 may be considered. Further, the spectacle lens was configured with optical elements as detailed in the parameters listed in Tables 2-5 for the MTF modelling of FIGS. 38-46 and FIGS. 48-55 which describe the different example embodiments of the current disclosure in detail.

Further, it is understood that the scope of the invention can be extended to spectacle lenses with other lens parameters, e.g., different front and back surface radii, that also result in the correction of the myopic eye.

When comparing the off-axis through-focus MTFs between 23° and 40° about the image plane between optical elements with and without tilt, the effect of tilt was assessed for an MTF threshold of 0.075. In other embodiments, alternative MTF thresholds may be used, for example, in some embodiments, a threshold of 0.05, 0.1 or 0.15 may be used, while performing optical modelling routines with other embodiments, a threshold for MTF value may be between 0.05 and 0.15.

FIG. 38 illustrates an example of a tilted axicon (3811) which has vector tilt applied to y coordinates, and which has a base shape that is non-circular and non-elliptical as illustrated in the XY plane cross section. A hypothetical non-tilted axicon (3801) with circular base shape is illustrated for reference. YZ plane cross sections (3802, 3812) and XZ plane cross sections (3803, 3813) are illustrated for the non-tilted reference axicon (3801) and the tilted axicon (3811). In the tilted axicon example (3811), positive y coordinates (3807) and negative y coordinates (3808) are each offset and scaled independently, applying a unique vector stretch or compression to only the y coordinates of the upper (3804) and lower (3805) halves of the non-tilted reference axicon (3801), applying the vector tilt coordinate transformation (3820) required to create the vector tilt as illustrated in the cross section (3812) of the tilted axicon (3811). The transform results in the sagittal height peak (3806) shifting along the y axis in the direction of, and by magnitude of the tilt factor (t) (3816). Tilted axicon example (3811) depicts a tilt of magnitude t=−0.5 which results in the sagittal height peak (3806) shifting in y by −0.5 units (3816). The element profiles as projected in the XZ cross sections (3803, 3813) are unchanged by the vector tilt transformation (3820). The width (x size) and the length (y size) of the base or the footprint size remain unchanged after the vector tilt transformation. A mathematical expression to describe this example transformation may be:

$$y = ( {y}_{t} - t ) / ( 1 + t \cdot Sign ( t - {y}_{t} ) )$$

where yₜ is in the coordinate space of the transformed tilted axicon (3811), y is in the coordinate space of the untransformed non-tilted reference axicon (3801), and t is the magnitude and direction of the tilt transform, wherein the sagittal height peak shift with positive t shifts the peak in the positive y direction. Other embodiments of tilt may include elements where the tilt is applied to a lensacon type reference element or other reference optical elements with a cross section shaped with a circular, conic, aspheric, or other profile. In further embodiments tilt may be applied to a reference element formed by azimuthally blending a combination of at least two of said cross-sectional profiles. Alternate embodiments may apply the vector tilt transformation to x coordinates, or any other meridian not coincident with the x or y axes of the reference optical element. Tilt on said other meridians may be achieved by applying affine rotation by the azimuth of said meridian before applying said equation to perform the vector tilt transformation, followed by affine rotation by the negative of the azimuth of said meridian.

$$[ UNTILTED ] \to Rotate ( meridian angle ) \to tilt \to Rotate ( - meridian angle ) \to [ TILTED ]$$

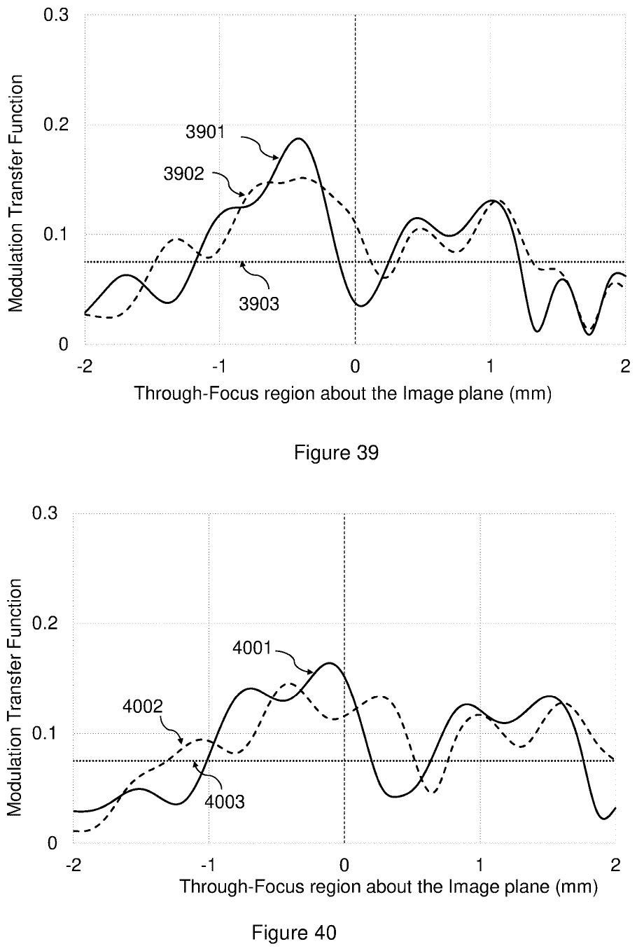

FIGS. 39 to 42 compare the off-axis through-focus MTFs about the image plane (retina, at 0 mm) obtained through a spectacle lens (Rx: −3 D) configured with axicons without tilt (3901, 4001, 4101, 4201) (as described in FIG. 24 and as disclosed previously in WO 2021/159170) and a spectacle lens (Rx: −3 D) configured with tilted axicons (3902, 4002, 4102, 4202) (as described in FIG. 25 and as detailed in the current disclosure) to correct a −3 D myopic model eye (Table 1). Table 2 lists the parameters (height and base diameter) of axicons with and without tilt and their corresponding total TFRIS (TFRIS, in mm) as defined over an MTF threshold of 0.075 at visual field angles of 28°, 33°, 36° and 40°. For the design of the tilted axicon, the tilt transformation, as described in FIG. 38, was applied.

TABLE 2
Difference in the TFRIS (TFRIS, in mm) that is achieved
at visual angles of 28°, 33°, 36° and
40° for axicons with and without tilt.

| | | | Visual | | | Total |
|---|---|---|---|---|---|---|
| | | Base | Field | | Total | TFRIS |
| Type of | Height | diameter | Angle | Tilt | TFRIS | difference |
| element | (μm) | (mm) | (°) | (mm) | (mm) | (mm) |
| Axicon | 1.664 | 0.77 | 28 | 0.00 | 1.060 | 0.520 |
| | | | | 0.13 | 1.580 | |
| | 1.482 | 0.73 | 33 | 0.00 | 1.200 | 0.600 |
| | | | | 0.19 | 1.800 | |
| | 1.582 | 0.75 | 36 | 0.00 | 1.280 | 0.640 |
| | | | | 0.23 | 1.920 | |
| | 1.582 | 0.75 | 40 | 0.00 | 1.460 | 0.920 |
| | | | | 0.25 | 2.380 | |

FIG. 39 and Table 2 show that at the visual field angle of 28° and over the defined MTF threshold of 0.075 (3903), the tilted axicon (i.e., 0.13 mm tilt) (3902) resulted in a difference or an extension of the total TFRIS by 0.520 mm when compared to the axicon without tilt (3901). The TFRIS in front of the retina is 1.060 mm for the axicon without tilt (3901) and 1.480 mm for the axicon with tilt (3902). The TFRIS behind the retina is 0 mm for the axicon without tilt (3901) and 0.100 mm for the axicon with tilt (3902).

FIG. 40 and Table 2 show that at the visual field angle of 33° and over the defined MTF threshold of 0.075 (4003), the tilted axicon (i.e., 0.19 mm tilt) (4002) resulted in an extension of the total TFRIS by 0.600 mm when compared to the axicon without tilt (4001). The TFRIS in front of the retina is 1.000 mm for the axicon without tilt (4001) and 1.300 mm for the axicon with tilt (4002). The TFRIS behind the retina is 0.200 mm for the axicon without tilt (4001) and 0.500 mm for the axicon with tilt (4002).

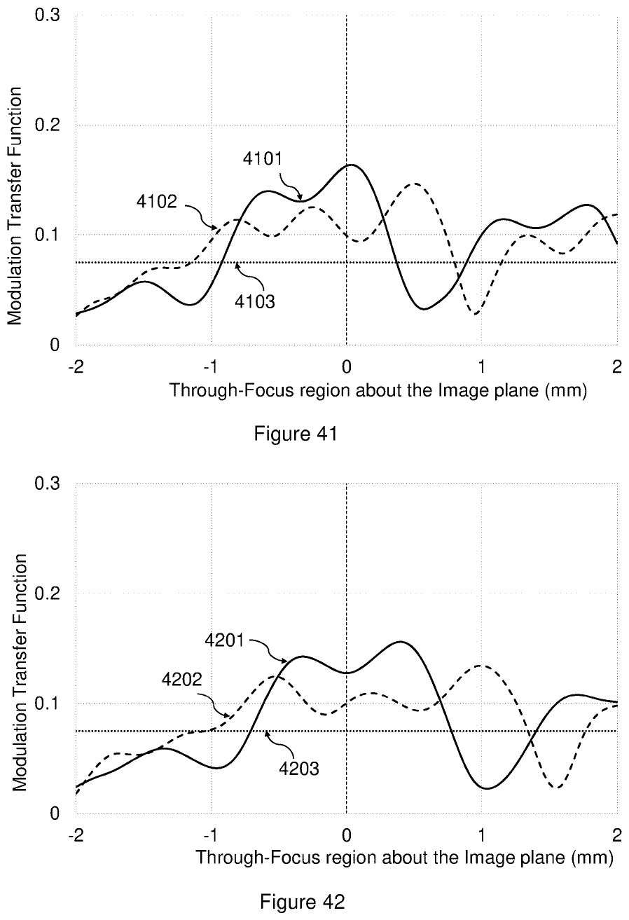

FIG. 41 and Table 2 show that at the visual field angle of 36° and over the defined MTF threshold of 0.075 (4103), the tilted axicon (i.e., 0.23 mm tilt) (4102) resulted in an extension of the total TFRIS by 0.640 mm when compared to the axicon without tilt (4101). The TFRIS in front of the retina is 0.920 mm for the axicon without tilt (4101) and 1.140 mm for the axicon with tilt (4102). The TFRIS behind the retina is 0.360 mm for the axicon without tilt (4101) and 0.780 mm for the axicon with tilt (4102).

FIG. 42 and Table 2 show that at the visual field angle of 40° and over the defined MTF threshold of 0.075 (4203), the tilted axicon (i.e., 0.25 mm tilt) (4202) resulted in an extension of the total TFRIS by 0.920 mm when compared to the axicon without tilt (4201). The TFRIS in front of the retina is 0.700 mm for the axicon without tilt (4201) and 1.040 mm for the axicon with tilt (4202). The TFRIS behind the retina is 0.765 mm for the axicon without tilt (4201) and 1.340 mm for the axicon with tilt (4202).

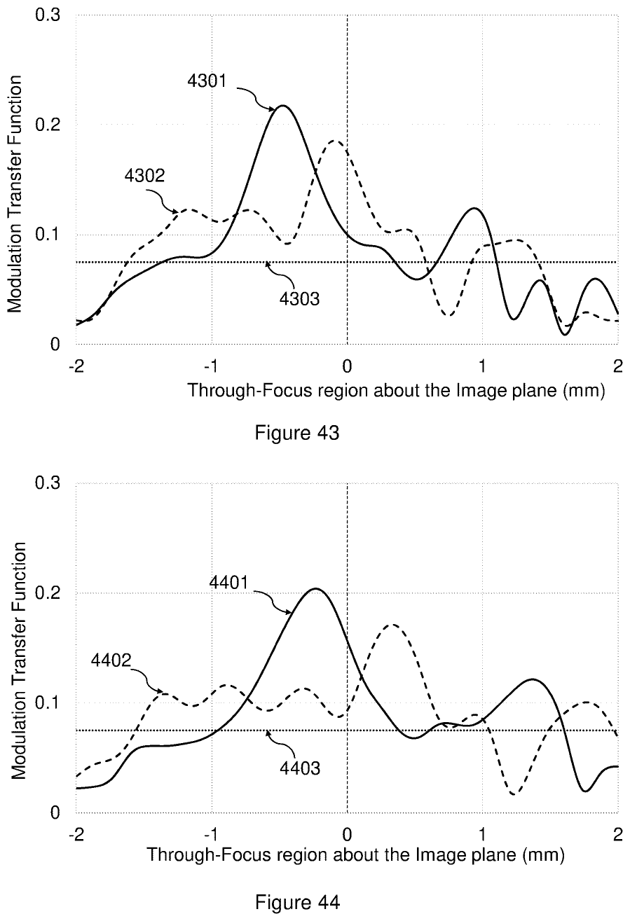

FIGS. 43 to 46 compare the off-axis through-focus MTFs about the image plane (retina, at 0 mm) obtained through a spectacle lens (Rx: −3 D) configured with lensacons without tilt (4301, 4401, 4501, 4601) (as described in FIG. 2 and as disclosed previously in WO 2021/159170) and a spectacle lens (Rx: −3 D) configured with tilted lensacons (4302, 4402, 4502, 4602) (as described in FIGS. 4 and 5 and as detailed in the current disclosure) to correct a −3 D myopic model eye (Table 1). Table 3 lists the parameters (height, diameter of the curved top) and base diameter) of lensacons with and without tilt and their corresponding total TFRIS (TFRIS, in mm) as defined over an MTF threshold of 0.075 at visual field angles of 28°, 33°, 36° and 40°. For the design of the tilted lensacon, the tilt transformation, as described in FIG. 38, was applied.

TABLE 3
Difference in the TFRIS (TFRIS, in mm) that is achieved at visual angles
of 28°, 33°, 36° and 40° for lensacons with and without tilt.

| | | Curved | | Visual | | | Total |
|---|---|---|---|---|---|---|---|
| | | lens top | Base | Field | | Total | TFRIS |
| Type of | Height | diameter | diameter | Angle | Tilt | TFRIS | difference |
| element | (μm) | (mm) | (mm) | (°) | (mm) | (mm) | (mm) |
| Lensacon | 1.664 | 0.15 | 0.77 | 28 | 0.00 | 1.640 | 0.540 |
| | | | | | 0.28 | 2.180 | |
| | 1.520 | 0.15 | 0.73 | 33 | 0.00 | 1.320 | 1.280 |
| | | | | | 0.34 | 2.600 | |
| | 1.582 | 0.10 | 0.75 | 36 | 0.00 | 1.420 | 1.060 |
| | | | | | 0.36 | 2.480 | |
| | 1.582 | 0.10 | 0.75 | 40 | 0.00 | 1.540 | 1.380 |
| | | | | | 0.36 | 2.920 | |

FIG. 43 and Table 3 show that at the visual field angle of 28° and over the defined MTF threshold of 0.075 (4303), the tilted lensacon (i.e., 0.28 mm tilt) (4302) resulted in a difference or an extension of the total TFRIS by 0.540 mm when compared to the lensacon without tilt (4301). The TFRIS in front of the retina is 1.300 mm for the lensacon without tilt (4301) and 1.620 mm for the lensacon with tilt (4302). The TFRIS behind the retina is 0.340 mm for the lensacon without tilt (4301) and 0.560 mm for the lensacon with tilt (4302).

FIG. 44 and Table 3 show that at the visual field angle of 33° and over the defined MTF threshold of 0.075 (4403), the tilted lensacon (i.e., 0.34 mm tilt) (4402) resulted in an extension of the total TFRIS by 1.280 mm when compared to the lensacon without tilt (4401). The TFRIS in front of the retina is 0.940 mm for the lensacon without tilt (4401) and 1.560 mm for the lensacon with tilt (4402). The TFRIS behind the retina is 0.380 mm for the lensacon without tilt (4401) and 1.040 mm for the lensacon with tilt (4402).

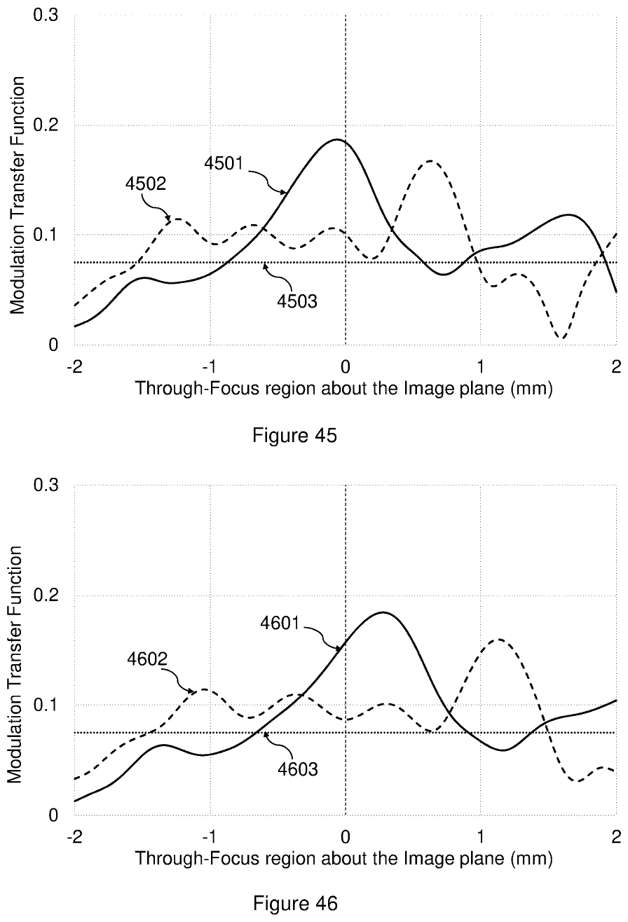

FIG. 45 and Table 3 show that at the visual field angle of 36° and over the defined MTF threshold of 0.075 (4503), the tilted lensacon (i.e., 0.36 mm tilt) (4502) resulted in an extension of the total TFRIS by 1.060 mm when compared to the lensacon without tilt (4501). The TFRIS in front of the retina is 0.86 mm for the lensacon without tilt (4501) and 1.520 mm for the lensacon with tilt (4502). The TFRIS behind the retina is 0.560 mm for the lensacon without tilt (4501) and 0.960 mm for the lensacon with tilt (4502).

FIG. 46 and Table 3 show that at the visual field angle of 40° and over the defined MTF threshold of 0.075 (4603), the tilted lensacon (i.e., 0.36 mm tilt) (4602) resulted in an extension of the total TFRIS by 1.380 mm when compared to the lensacon without tilt (4601). The TFRIS in front of the retina is 0.640 mm for the lensacon without tilt (4601) and 1.440 mm for the lensacon with tilt (4602). The TFRIS behind the retina is 0.900 mm for the lensacon without tilt (4601) and 1.480 mm for the lensacon with tilt (4602).

In other embodiments, the tilted optical elements may be tilted linear axicons, tilted logarithmic axicons, tilted fraxicons, tilted axilenses, or other titled non-extruded optical elements. For example, in addition to the tilt, the curvature of the fraxicon or lensacon may be optimised as a function of visual field angle to permit an increase in through-focus light intensity with a peak in front of or behind the retina.

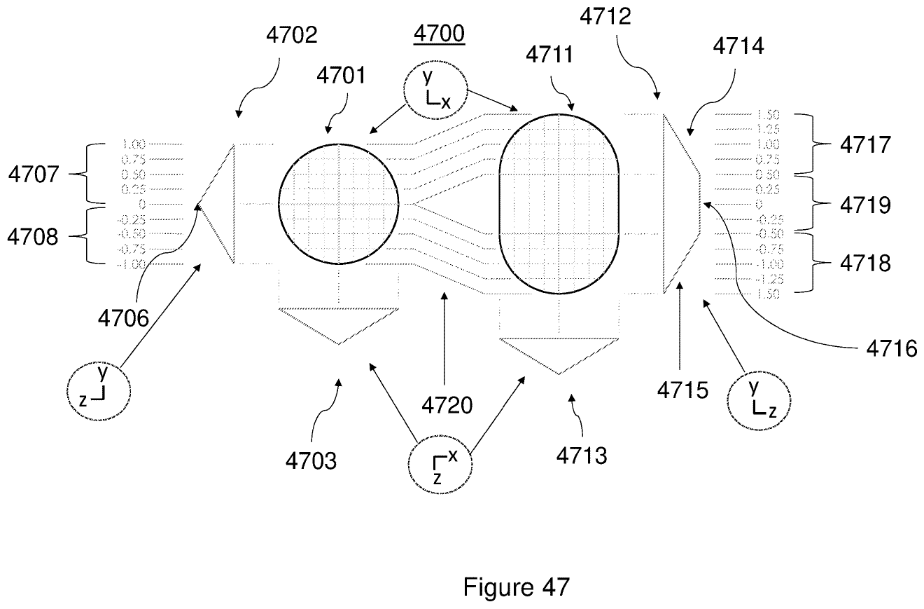

FIG. 47 illustrates an example of an extruded axicon (4711) of the current disclosure which is extruded or extruded along the y axis of the example element. A hypothetical non-extruded reference axicon (4701) with a circular base shape is illustrated for reference. YZ plane cross sections (4702, 4712) and XZ plane cross sections (4703, 4713) are illustrated for the non-extruded axicon (4701) and the extruded axicon (4711). In this extruded axicon example (4711), positive y coordinates (4707) and negative y coordinates (4708) are each offset in a direction moving their y coordinates away from the XZ plane (4717, 4718), creating the connecting element (4716) in the coordinate space (4719) between the upper (5614) and lower (5615) halves of the now extruded axicon (4711). This extrusion transformation is represented symbolically (4720). The new coordinate space (i.e., the connecting element) inserted between the upper and lower halves (4719) of the extruded axicon (4711) is bounded by y limits of + (extrusion length/2) and has a constant XZ cross-sectional profile at any value of y within these bounds. The transform results in the sagittal height peak (4706) stretching from a point (4706) to a line (4716) parallel with the y axis of length determined by the magnitude of the extrusion control parameter (a). Extruded axicon example (4711) depicts an extrusion of magnitude a=1.0 which results in the sagittal height peak (4706) being a line (4716) of length 1.0 mm (4719). The element profiles as projected in the XZ cross sections (4703, 4713) are unchanged by the extrusion transformation (4720). The width of the base or the footprint (x size) remains unchanged after the extrusion transformation. The length of the base or the footprint (y size) increases by the extrusion magnitude (a) after the extrusion transformation. A mathematical expression to describe this example transformation may be:

$$y = \{ \begin{matrix}{y}_{t} + \frac{a}{2} , & if ( {y}_{t} < - \frac{a}{2} ) \\ 0 , & if ( \vert {y}_{t} \vert \leq \frac{a}{2} ) \\ {y}_{t} - \frac{a}{2} , & if ( {y}_{t} > \frac{a}{2} )\end{matrix}$$

where yₜ is in the coordinate space of the transformed extruded axicon (4711), y is in the coordinate space of the non-extruded reference axicon (4701), and a is the non-negative extrusion control parameter. Other embodiments may include elements where the extrusion is applied to a lensacon or a reference optical element with a cross section shaped with circular, conic, aspheric, or other profile. In further embodiments extrusion may be applied to reference elements formed by azimuthally blending a combination of at least two of said cross-sectional profiles. Alternate embodiments may apply the extrusion along x coordinates, or any other meridian not coincident with the x or y axes. Extrusion on said other meridians may be achieved by applying affine rotation by the azimuth of said meridian before applying said equation to perform the extrusion transformation, followed by affine rotation by the negative of the azimuth of said meridian.

$$[ UNEXTENDED ] \to Rotate ( meridian angle ) \to extend \to Rotate ( - meridian angle ) \to [ EXTENDED ]$$

Certain embodiments may combine features of an extruded element and a tilted element to create an element which is both extruded and tilted (FIG. 14). When creating said element, extension and tilt may be applied along different axes. Examples illustrated in FIG. 14 depict elements combining vector tilt applied along the y axis and extension applied along the x axis to create the final extruded tilted element. In other embodiments, extension and tilt may be independently applied to any axis of the reference optical element for both extension and tilt transformations, or in further embodiments the transformations may be applied along a common axis.

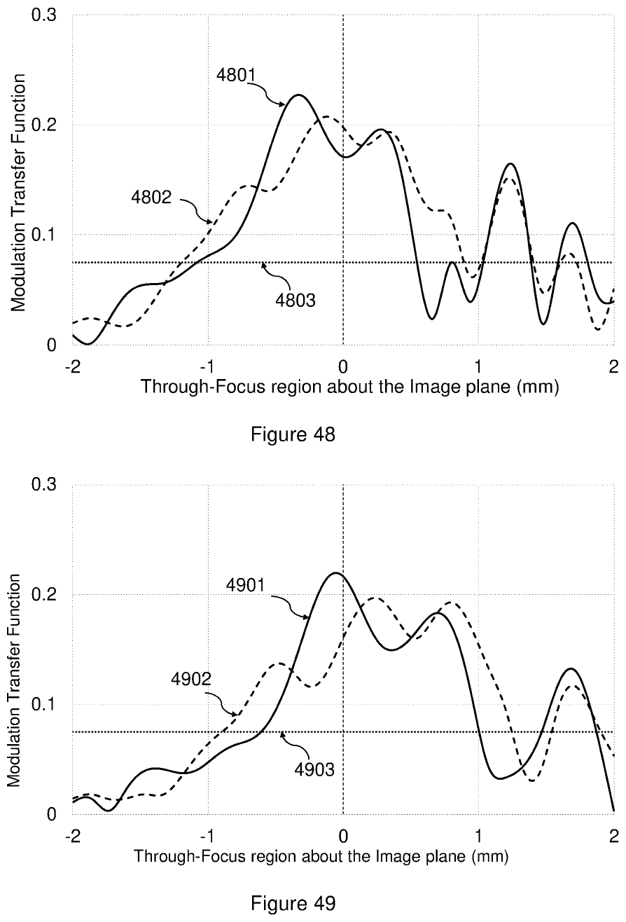

FIGS. 48 to 51 compare the off-axis through-focus MTFs about the image plane (retina, at 0 mm) obtained through a spectacle lens (Rx: −3 D) configured with an extruded axicon without tilt (4801, 4901, 5001, 5101) (as described in FIGS. 11 and 14 of the current disclosure) and a spectacle lens (Rx: −3 D) configured with extruded axicon with tilt (4802, 4902, 5002, 5102) (as described in FIG. 14 of the current disclosure) to correct a −3 D myopic model eye (Table 1). Table 4 lists the parameters (height, extension (i.e., length of the inner connecting element) and base diameter) of the extruded axicons with and without tilt and their corresponding total TFRIS (TFRIS, in mm) as defined over an MTF threshold of 0.075 at visual field angles of 28°, 33°, 36° and 40°. For the design of the extruded axicons the extrusion transformation, as described in FIG. 47, was applied. For the design of the extruded tilted axicons the extrusion transformation, as described in FIG. 47, and the tilt transformation, as described in FIG. 38, were applied, wherein the tilt transformation was performed along the axis perpendicular to the axis along which the extrusion was performed. In other embodiments, the tilt transformation may be performed along the axis parallel to the axis along which the extrusion is performed.

TABLE 4
Difference in the TFRIS (TFRIS, in mm) that is achieved at visual angles
of 28°, 33°, 36° and 40° for extruded axicons with and without tilt.

| | | | | Visual | | | Total |
|---|---|---|---|---|---|---|---|
| | | | Base | Field | | Total | TFRIS |
| Type of | Height | Extrusion | Diameter | Angle | Tilt | TFRIS | difference |
| element | (μm) | (mm) | (mm) | (°) | (mm) | (mm) | (mm) |
| Extruded | 1.26 | 0.25 | 0.78 | 28 | 0.00 | 1.590 | 0.440 |
| axicon | | | | | 0.17 | 2.085 | |
| | 1.26 | 0.10 | 0.78 | 33 | 0.00 | 1.605 | 0.520 |
| | | | | | 0.20 | 2.130 | |
| | 1.96 | 0.20 | 0.78 | 36 | 0.00 | 1.080 | 1.060 |
| | | | | | 0.15 | 1.950 | |
| | 1.96 | 0.20 | 0.78 | 40 | 0.00 | 1.215 | 1.440 |
| | | | | | 0.15 | 2.355 | |

FIG. 48 and Table 4 show that at the visual field angle of 28° and over the defined MTF threshold of 0.075 (4803), the tilted extruded axicon (i.e., 0.17 mm tilt) (4802) resulted in a difference or an extension of the total TFRIS by 0.440 mm when compared to the extruded axicon without tilt (4801). The TFRIS in front of the retina is 1.080 mm for the extruded axicon without tilt (4801) and 1.180 mm for the extruded axicon with tilt (4802). The TFRIS behind the retina is 0.540 mm for the extruded axicon without tilt (4801) and 0.880 mm for the extruded axicon with tilt (4802).

FIG. 49 and Table 4 show that at the visual field angle of 33° and over the defined MTF threshold of 0.075 (4903), the tilted extruded axicon (i.e., 0.2 mm tilt) (4802) resulted in an extension of the total TFRIS by 0.520 mm when compared to the extruded axicon without tilt (4901). The TFRIS in front of the retina is 0.600 mm for the extruded axicon without tilt (4901) and 0.880 mm for the extruded axicon with tilt (4902). The TFRIS behind the retina is 1.000 mm for the extruded axicon without tilt (4901) and 1.240 mm for the extruded axicon with tilt (4902).

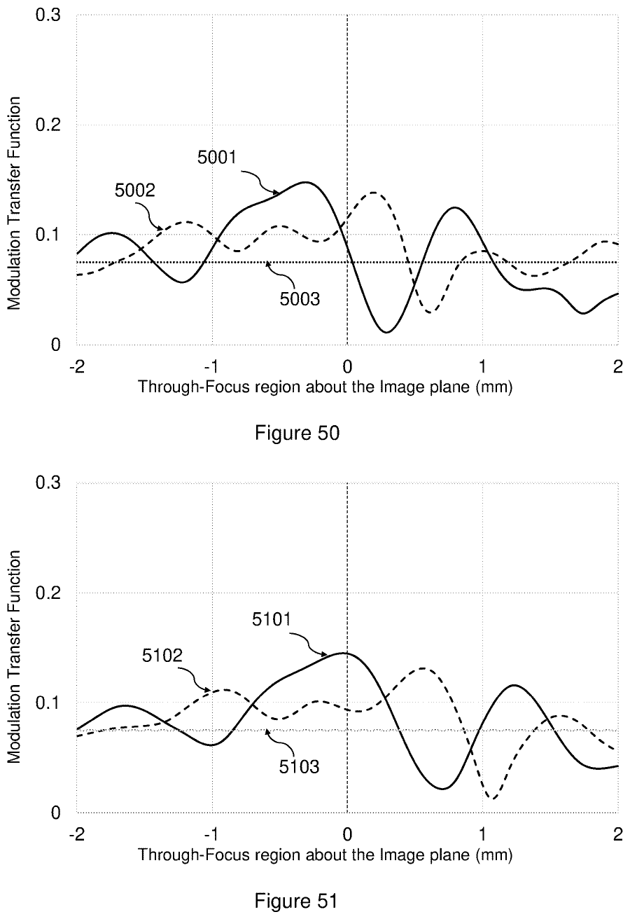

FIG. 50 and Table 4 show that at the visual field angle of 36° and over the defined MTF threshold of 0.075 (5003), the tilted extruded axicon (i.e., 0.15 mm tilt) (5002) resulted in an extension of the total TFRIS by 1.060 mm when compared to the extruded axicon without tilt (5001). The TFRIS in front of the retina is 1.060 mm for the extruded axicon without tilt (5001) and 1.700 mm for the extruded axicon with tilt (5002). The TFRIS behind the retina is 0.020 mm for the extruded axicon without tilt (5001) and 0.440 mm for the extruded axicon with tilt (5002).

FIG. 51 and Table 4 show that at the visual field angle of 40° and over the defined MTF threshold of 0.075 (5103), the tilted extruded axicon (i.e., 0.15 mm tilt) (5102) resulted in an extension of the total TFRIS by 1.440 mm when compared to the extruded axicon without tilt (5101). The TFRIS in front of the retina is 0.840 mm for the extruded axicon without tilt (5101) and 1.800 mm for the extruded axicon with tilt (5102). The TFRIS behind the retina is 0.380 mm for the extruded axicon without tilt (5101) and 0.860 mm for the extruded axicon with tilt (5102).

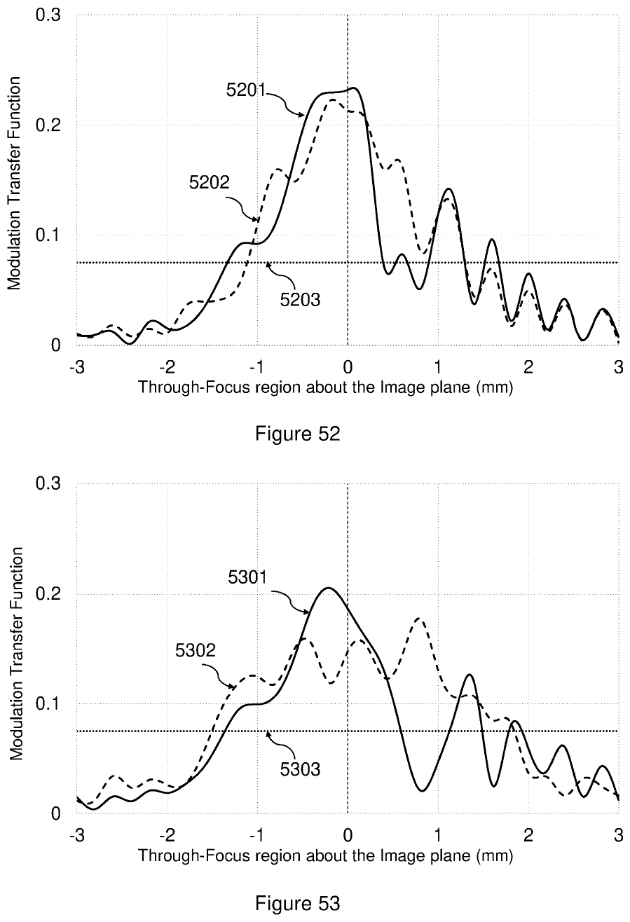

FIGS. 52 to 55 compare the off-axis through-focus MTFs about the image plane (retina, at 0 mm) obtained through a spectacle lens (Rx: −3 D) configured with an extruded lensacon without tilt (5201, 5301, 5401, 5501) (as described in FIGS. 12, 14 and 16 of the current disclosure) and a spectacle lens (Rx: −3 D) configured with extruded tilted lensacons (5202, 5302, 5402, 5502) (as described in FIG. 14 of the current disclosure) to correct a −3 D myopic model eye (Table 1). Table 5 lists the parameters (height, extrusion (i.e., length of the inner connecting element), dome diameter (curved top) and base diameter) of the extruded lensacon with and without tilt and their corresponding total TFRIS (TFRIS, in mm) as defined over an MTF threshold of 0.075 at visual field angles of 28°, 33°, 36° and 40° for the design of the extruded lensacons the extrusion transformation, as described in FIG. 47, was applied. For the design of the extruded tilted lensacons the extrusion transformation, as described in FIG. 47, and the tilt transformation, as described in FIG. 38, were applied, wherein the tilt transformation was performed along the axis perpendicular to the axis along which the extrusion was performed. In other embodiments, the tilt transformation may be performed along the axis parallel to the axis along which the extrusion is performed.

TABLE 5
Difference in the TFRIS (TFRIS, in mm) that is achieved at visual angles
of 28°, 33°, 36° and 40° for extruded lensacons with and without tilt.

| | | | Curved | | Visual | | | Total |
|---|---|---|---|---|---|---|---|---|
| | | | Lens top | Base | Field | | Total | TFRIS |
| Type of | Height | Extrusion | Diameter | Diameter | Angle | Tilt | TFRIS | difference |
| element | (μm) | (mm) | (mm) | (mm) | (°) | (mm) | (mm) | (mm) |
| Extruded | 1.36 | 0.25 | 0.125 | 0.78 | 28 | 0.00 | 1.710 | 0.690 |
| lensacon | | | | | | 0.17 | 2.400 | |
| | 1.56 | 0.20 | 0.150 | 0.78 | 33 | 0.00 | 1.920 | 1.410 |
| | | | | | | 0.30 | 3.300 | |
| | 1.56 | 0.20 | 0.125 | 0.78 | 36 | 0.00 | 2.220 | 1.680 |
| | | | | | | 0.35 | 3.900 | |
| | 1.76 | 0.15 | 0.125 | 0.78 | 40 | 0.00 | 2.100 | 0.600 |
| | | | | | | 0.10 | 2.700 | |

FIG. 52 and Table 5 show that at the visual field angle of 28° and over the defined MTF threshold of 0.075 (5203), the tilted extruded lensacon (i.e., 0.17 mm tilt) (5102) resulted in a difference or an extension of the total TFRIS by 0.690 mm when compared to the extruded lensacon without tilt (5201). The TFRIS in front of the retina is 1.320 mm for the extruded lensacon without tilt (5201) and 1.110 mm for the extruded lensacon with tilt (5202). The TFRIS behind the retina is 0.390 mm for the extruded lensacon without tilt (5201) and 1.290 mm for the extruded lensacon with tilt (5202).

FIG. 53 and Table 5 show that at the visual field angle of 33° and over the defined MTF threshold of 0.075 (5303), the tilted extruded lensacon (i.e., 0.30 mm tilt) (5302) resulted in an extension of the total TFRIS by 1.410 mm when compared to the extruded lensacon without tilt (5301). The TFRIS in front of the retina is 1.350 mm for the extruded lensacon without tilt (5301) and 1.500 mm for the extruded lensacon with tilt (5302). The TFRIS behind the retina is 0.570 mm for the extruded lensacon without tilt (5301) and 1.830 mm for the extruded lensacon with tilt (5302).

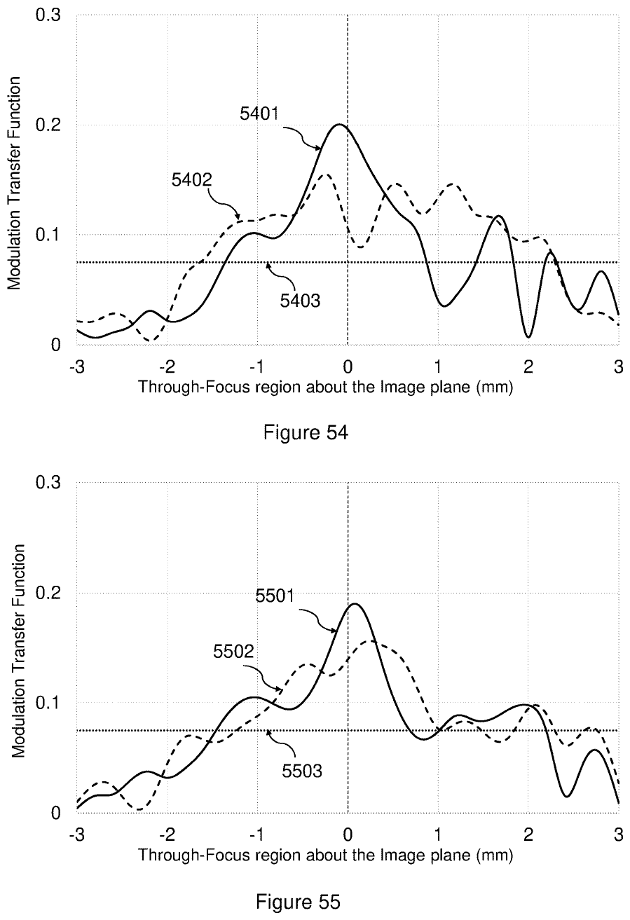

FIG. 54 and Table 5 show that at the visual field angle of 36° and over the defined MTF threshold of 0.075 (5403), the tilted extruded lensacon (i.e., 0.35 mm tilt) (5302) resulted in an extension of the total TFRIS by 1.680 mm when compared to the extruded lensacon without tilt (5401). The TFRIS in front of the retina is 1.350 mm for the extruded lensacon without tilt (5401) and 1.620 mm for the extruded lensacon with tilt (5402). The TFRIS behind the retina is 0.870 mm for the extruded lensacon without tilt (5401) and 2.280 mm for the extruded lensacon with tilt (5402).

FIG. 55 and Table 5 show that at the visual field angle of 40° and over the defined MTF threshold of 0.075 (5503), the tilted extruded lensacon (i.e., 0.10 mm tilt) (5502) resulted in an extension of the total TFRIS by 0.600 mm when compared to the extruded lensacon without tilt (5501). The TFRIS in front of the retina is 1.440 mm for the extruded lensacon without tilt (5501) and 1.230 mm for the extruded lensacon with tilt (5502). The TFRIS behind the retina is 0.660 mm for the extruded lensacon without tilt (5501) and 1.470 mm for the extruded lensacon with tilt (5502).

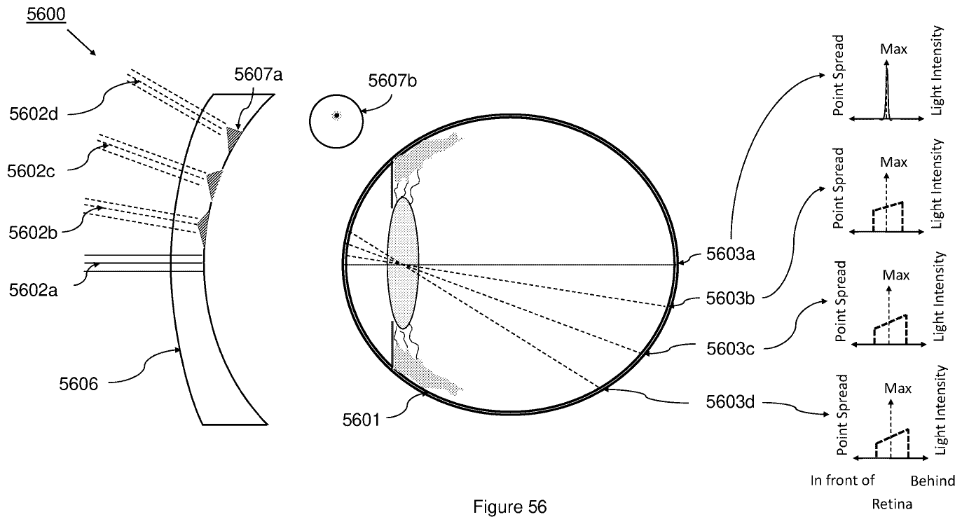

FIG. 56 illustrates a schematic diagram (5600, not to scale) of an on-axis and off-axis, TFRIS (5603 a-d), when the incoming light (0°, 5602a; 10°, 5602b; 20°, 5602c; 30°, 5603d), with a visible wavelength (e.g., 555 nm) and vergence of 0 D, depicting optical infinity, is incident on a myopic model eye (5601) (e.g., −2D) corrected with a myopia management spectacle lens embodiment (5606) of the current disclosure with tilted axicons (5607a and 5607b). In this example, the myopia management spectacle lens (5606) is configured with tilted axicons (5607a) that are located for incoming light at 10° (5602b), 20° (5602c) and 30° (5602d). In other examples, the tilted optical elements may be tilted lensacons or tilted axicon-like elements (e.g., logarithmic axicons, fraxicons). In other examples, the location of the tilted optical elements may be for incoming light ranging between 0° and 20°, 0° and 40°, 10° and 30°, 10° and 50° and 0° and 50°. When compared to the example embodiment of the previous disclosure (WO 2021/159170), the tilted axicons (5607a) provide an increase of the light intensity of the TFRIS when compared to a spectacle lens as disclosed previously in WO 2021/159170 without the tilt. Further, the parameters of the tilted optical elements result in a non-uniform light intensity of the TFRIS wherein the magnitude in light intensity is greater behind the retina when compared to in front of the retina.

FIG. 57 provides an example of the schematic diagram shown in FIG. 56, wherein the tilted axicon provides a greater increase in light intensity of the TFRIS behind the retina. FIG. 57 shows that at the visual field angle of 33° and over the defined MTF threshold of 0.075 (5703), the tilted axicon (i.e., −0.55 mm tilt) (5702) resulted in an extension of the total TFRIS by 0.64 mm when compared to the axicon without tilt (5701). The TFRIS in front of the retina is 0.28 mm for the axicon without tilt (5701) and 0.68 mm for the axicon with tilt (5702). The TFRIS behind the retina is 0.92 mm for the axicon without tilt (5701) and 1.16 mm for the axicon with tilt (5702).

FIG. 58 shows that an extruded tilted optical element can provide a greater increase in the light intensity of the TFRIS than a non-extruded tilted optical element as well as a greater peak MTF. In this example, at the visual field angle of 28° and over the defined MTF threshold of 0.075 (5803), the tilted extruded axicon (i.e., 0.17 mm tilt) (5802) resulted in a difference or an extension of the total TFRIS by 0.48 mm when compared to the non-extruded tilted axicon (5801) (i.e., 0.13 mm tilt). Further, the peak MTF for the extruded tilted axicon was higher, i.e., 0.208 than the peak MTF for the tilted non-extruded axicon, i.e., 0.056. In addition to the increased light intensity of the TFRIS, a greater peak MTF may provide better visual performance.

In other embodiments, the extruded optical elements with or without tilt may be configured of combinations of spherical, toric, axicon-like, fraxicon-like or lensacon-like outer semi-elements and/or the connecting elements may have a spherical or lensacon-like profile with centred or tilted axis. In addition to the tilt, the curvature of the fraxicon or lensacon may be optimised as a function of visual field angle to permit an increase in through-focus light intensity with a peak in front of or behind the retina.

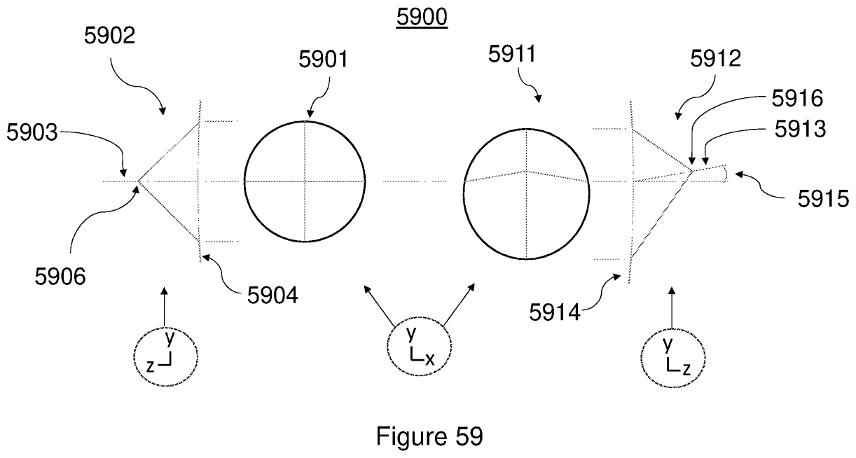

FIG. 59 illustrates an example of a geometrically tilted axicon (5911) which has a circular base shape and geometric tilt applied. A hypothetical non-tilted reference axicon (5901) with circular base shape is illustrated for reference. YZ plane cross sections (5902, 5912) are illustrated for the non-tilted reference axicon (5901) and the geometrically tilted axicon (5911). In this geometrically tilted axicon example (5911), the geometrical coordinate space of the element is tilted in the YZ plane using an affine rotation operation, resulting in reference axicon z axis (5903) being geometrically tilted (5913) by a geometrical tilt angle (5915) to create the geometrically tilted axicon (5911). The transform results in a shift of the sagittal height peak (5906) of the reference axicon (5901) to the sagittal height peak (5916) of the geometrically tilted axicon (5911). A mathematical expression to describe this affine tilt transformation may be:

$$[ \begin{matrix}{x}_{t} \\ {y}_{t} \\ {z}_{t}\end{matrix} ] [ \begin{matrix}1 & 0 & 0 \\ 0 & cos θ & sin θ \\ 0 & - sin θ & cos θ\end{matrix} ] [ \begin{matrix}x \\ y \\ 1\end{matrix} ]$$

where (xₜ, yₜ, zₜ) is in the coordinate space of the transformed element, i.e., the geometrically tilted axicon (5911), (x, y, z) is in the coordinate space of the untransformed base element, i.e., the non-tilted reference axicon (5901), and θ is the magnitude and direction of the tilt in the YZ plane. Other embodiments of geometric tilt may include elements where the tilt is applied to a lensacon type reference element or other reference optical elements with a cross section shaped with a circular, conic, aspheric, or other profile. In further embodiments tilt may be applied to a reference element formed by azimuthally blending a combination of at least two of said profiles. Alternate embodiments may apply the geometric tilt transformation in a plane other than the YZ plane. Tilt on said other planes may be achieved by defining an axis about which the tilt is applied and describing said axis as a unit vector, then transforming by an equation such as:

$$[ \begin{matrix}{x}_{t} \\ {y}_{t} \\ {z}_{t}\end{matrix} ] = [ \begin{matrix}\begin{matrix}u \cdot u \cdot ( 1 - cos θ ) + \\ cos θ\end{matrix} & \begin{matrix}u \cdot v \cdot ( 1 - cos θ ) - \\ w \cdot sin θ\end{matrix} & \begin{matrix}u \cdot w \cdot ( 1 - cos θ ) + \\ v \cdot sin θ\end{matrix} \\ \begin{matrix}v \cdot u \cdot ( 1 - cos θ ) + \\ w \cdot sin θ\end{matrix} & \begin{matrix}v \cdot v \cdot ( 1 - cos θ ) + \\ cos θ\end{matrix} & \begin{matrix}v \cdot w \cdot ( 1 - cos θ ) - \\ u \cdot sin θ\end{matrix} \\ \begin{matrix}w \cdot u \cdot ( 1 - cos θ ) - \\ v \cdot sin θ\end{matrix} & \begin{matrix}w \cdot v \cdot ( 1 - cos θ ) + θ \\ u \cdot sin\end{matrix} & \begin{matrix}w \cdot w \cdot ( 1 - cos θ ) + \\ cos θ\end{matrix}\end{matrix} ] [ \begin{matrix}x \\ y \\ z\end{matrix} ]$$

where (xₜ, yₜ, zₜ) is in the coordinate space of the transformed element, (x, y, z) is in the coordinate space of the untransformed reference element, (u, v, w) is the axis unit vector and θ is the angle and direction of tilt.

Certain embodiments may combine features of an extruded element and a geometrically tilted element to create an element which is both extruded and tilted. When creating said element, extension and geometrical tilt may be applied along different axes. In other embodiments, extension and geometrical tilt may be independently applied to any axis for both extension and geometrical tilt transformations, or in further embodiments the transformations may be applied along a common axis.

FIG. 60 illustrates the top view (6001) and the side view (6002) of a tilted optical element, i.e., a tilted lensacon (6000), which resembles the shape of a tilted cone with a curved lens top. The top view (6001) of the tilted lensacon illustrates the size of the lens top (6001e) and the size and shape of the non-circular, non-elliptical base (6001f) with the distances 6001j and 6001i being equal. The top view (6001) of the tilted lensacon further illustrates the tilted lensacon with an apex (6001a) that is decentered from the geometrical centre (6001g) of the non-circular, non-elliptical base (6001f) along the z-axis by distance (6001h). The side view (6002) of the tilted lensacon illustrates the apex (6002a) and the height of the tilted lensacon as defined by the combined height of the curved lens top (6002e) and the height of the lower axicon part (6002f). The side view (6002) further illustrates the steepness and the tilt of the tilted lensacon as defined by the angles (6002c) and (6002d). The shape of the base of the tilted optical element may be selected taking into consideration the ease of manufacture on any of the two spectacles lens surfaces, which may be spherical or aspherical.

The increase in the total TFRIS or an increase in the TFRIS in front or behind the retina with the tilted axicons, tilted lensacons, tilted extruded optical elements or other tilted optical elements may provide additional benefits for the slowing of myopia progression, when compared to the same elements without tilt.

In other examples of the current disclosure utilising tilted axicons or tilted lensacons or other tilted extruded or non-extruded optical elements, the extension of the total TFRIS when compared to axicons, lensacons or other extruded or non-extruded optical elements without tilt may be 0.1 mm, 0.2 mm, 0.4 mm, 0.8 mm, 1.2 mm, 1.5 mm, 2.0 mm, or 3.0 mm.

In other examples of the current disclosure utilising tilted axicons or tilted lensacons or other tilted extruded or non-extruded optical elements the extension of the total TFRIS when compared to axicons or lensacons or other extruded or non-extruded optical elements without tilt may range between 0.1 mm and 0.5 mm, 0.2 mm and 0.8 mm, 0.5 mm and 1.0 mm, 0.8 mm, and 3.0 mm.

In other examples of the current disclosure utilising tilted axicons or tilted lensacons or other tilted extruded or non-extruded optical elements the extension of the TFRIS in front of the retina when compared to axicons or lensacons or other extruded or non-extruded optical elements without tilt may be 0.1 mm, 0.2 mm, 0.4 mm, 0.8 mm, 1.2 mm, 1.5 mm, and 2.0 mm.

In other examples of the current disclosure utilising tilted axicons or tilted lensacons or other tilted extruded or non-extruded optical elements the extension of the TFRIS in front of the retina when compared to axicons or lensacons or other extruded or non-extruded optical elements without tilt may range between 0.1 mm and 0.4 mm, 0.2 mm and 0.8 mm, 0.4 mm and 1.2 mm, 0.4 mm and 1.5 mm, and 0.5 mm and 2.0 mm.

In other examples of the current disclosure utilising tilted axicons or tilted lensacons or other tilted extruded or non-extruded optical elements, the extension of the TFRIS behind the retina when compared to axicons or lensacons or other extruded or non-extruded optical elements without tilt may be 0.1 mm, 0.2 mm, 0.4 mm, 0.8 mm, 1.2 mm, 1.5 mm, and 2.0 mm.

In other examples of the current disclosure utilising tilted axicons or tilted lensacons or other tilted extruded or non-extruded optical elements the extension of the TFRIS behind the retina when compared to axicons or lensacons or other extruded or non-extruded optical elements without tilt may range between 0.1 mm and 0.4 mm, 0.2 mm and 0.8 mm, 0.4 mm and 1.2 mm, 0.4 mm and 1.5 mm, and 0.5 mm and 2.0 mm.

As a person skilled in the art may appreciate, the present invention may be used in combination with any of the devices/methods that have the potential to influence the progression of myopia.

These may include, but are not limited to, spectacle lenses of various designs, colour filters, pharmaceutical agents, behavioural changes, and environmental conditions.

Risk of developing myopia or progressive myopia may be based on one or more of the following factors: genetics, ethnicity, lifestyle, excessive near work, etc. Certain embodiments of the present disclosure are directed towards a person at a risk of developing myopia or progressive myopia with or without astigmatism.

In accordance with one of the embodiments, the present disclosure is directed to a myopia management spectacle lens for a myopic eye. The myopia management spectacle lens comprising a front surface, a back surface, an optic zone configured with a central distance zone of substantially single vision power to correct the myopic eye, an optical centre, and at least one peripheral treatment zone, wherein the at least one peripheral treatment zone comprises a plurality of tilted optical elements and/or extruded optical elements and/or extruded tilted optical elements surrounded by single vision power, wherein the optical elements are optimised such that they permit an increase in light intensity of the TFRIS, e.g., at various visual field angles.

Further, the choice of tilted optical elements and/or extruded optical elements and/or extruded tilted optical elements, the choice of the region within the at least one peripheral treatment zone, the number, size and amount of tilt of the tilted optical elements and/or extruded optical elements within the at least one peripheral treatment zone may be optimised to provide an optical stop signal for the different visual field angles, such that the treatment efficacy to reduce the rate of myopia progression can be increased.

Further, the choice of tilted optical elements and/or extruded optical elements and/or extruded tilted optical elements, the choice of the region within the at least one peripheral treatment zone, the number, size and amount of tilt of the tilted optical elements and/or extruded optical elements within the at least one peripheral treatment zone may be ascertained by considering various patient related factors, for example the magnitude of myopia, the onset of myopia, parental myopia, age, gender, and other risk factors generally associated with progression of myopia or high myopia as well as binocular visual performance.

A few other exemplary embodiments of the current disclosure are described in the following example claim set.

1. A myopia management spectacle lens comprising: an optical centre, a central zone configured with a distance prescription to provide foveal correction for a myopic eye, wherein said central zone is further surrounded by at least one peripheral treatment zone configured with at least one tilted and/or extruded optical element, wherein said tilted and/or extruded optical element is configured to increase the width of the through-focus retinal image spread (TFRIS) compared to the TFRIS obtained with the same optical element without tilt and/or extrusion, for at least one visual field angle to provide directional cues to the peripheral retina, serving as an optical signal to provide a reduction of myopia progression.

2. The myopia management spectacle lens of claim 1, wherein the shape of the central zone is circular, oval, or non-circular.

3. The myopia management spectacle lens of claim 1, wherein at least one tilted and/or extruded optical element increases the width of the TFRIS for at least one visual field angle between 5 to 50 degrees.

4. The myopia management spectacle lens of claim 1, wherein the at least one extruded optical element comprises two outer semi-elements and a connecting element; wherein the at least one extruded optical element is tilted or untilted; wherein the profile of the outer semi-elements is spherical or toric or asymmetric or axicon-like, or lensacon-like, axilens-like, or fraxicon-like, and wherein the profile of the connecting element is spherical, or toric, or asymmetric, or axicon-like, or lensacon-like, or axilens-like, or fraxicon-like.

5. The myopia management spectacle lens of claim 1, wherein the at least one extruded optical element with or without tilt is further configured with different combinations of outer semi-elements and a connecting element of differing profiles forming an apex line with an orientation.

6. The myopia management spectacle lens of claim 1, wherein the power profile distribution within the two outer semi-elements is configured using an asymmetrical power distribution.

7. The myopia management spectacle lens of claim 1, wherein the at least one tilted optical element is configured by applying a vector tilt transformation to a reference optical element, resulting in a tilted optical element; wherein the vector tilt transformation results in a base shape an elliptical, a circular, or an asymmetrical base.

8. The myopia management spectacle lens of claim 1, wherein the at least one extruded optical element is configured by applying an extrusion transformation to a reference optical element; wherein the extrusion transformation involves an extension or extrusion along the y-axis to create an extruded optical element from the reference optical element.

9. The myopia management spectacle lens of claim 1, wherein the at least one tilted or extruded optical element is configured by applying both the vector tilt transformation and the extrusion transformation to the reference optical element resulting in a tilted extruded optical element.

10. The myopia management spectacle lens of claim 1, wherein the reference optical element is an axicon, lensacon, fraxicon, or axilens.

11. The myopia management spectacle lens of claim 1, wherein the total number of tilted and/or extruded optical elements is at least 1, 5, 10, 15, 20, 25, 30, 35, 40, 45 or 50.

12. The myopia management spectacle lens of claim 1, wherein the spherical, toric, or min-max power of the two outer semi-elements is at least +0.75D, or between +0.75D and +3.5D.

13. The myopia management spectacle lens of claim 1, wherein the length of the extruded optical element is at least 0.05 mm, or between 0.05 mm and 2 mm.

14. The myopia management spectacle lens of claim 1, wherein the size of the base of the tilted and/or extruded optical element is between 1.2 and 3 mm in any direction.

15. The myopia management spectacle lens of claim 1, wherein the tilted and/or extruded optical elements vary in size between the peripheral treatment zones.

16. The myopia management spectacle lens of claim 1, wherein the tilted and/or extruded optical elements are arranged ring-like, hexagonal, squared, non-concentric, flower-like, petal-like, or randomly, and are separated or conjoined.

17. The myopia management spectacle lens of claim 1, wherein the tilted and/or extruded optical elements encompass at least 15%, 25%, 35%, or 50% of the optic zone, and the remainder of the optic zone is configured with a substantially single vision correction for the myopic eye.

18. The myopia management spectacle lens of claim 1, wherein the apex of the tilted or extruded optical element is separated from the centroid of the base of the tilted or extruded optical element by at least 5 microns to 50 microns.

19. The myopia management spectacle lens of claim 1, wherein the TFRIS is expressed as light intensity profile, point spread function (PSF), or modulation transfer function (MTF).

20. The myopia management spectacle lens of claim 1, wherein the increased width of TFRIS has a uniform light intensity profile, about the retina, for at least one visual field angle.

21. The myopia management spectacle lens of claim 1, wherein the increased width of TFRIS has a non-uniform light intensity profile, about the retina, for at least one visual field angle, such that the magnitude of the non-uniform light intensity is greater in front of the retina.

22. The myopia management spectacle lens of claim 1, wherein the increased width of TFRIS has a non-uniform light intensity profile, about the retina, for at least one visual field angle, such that the magnitude of the non-uniform light intensity is greater behind the retina.

23. The myopia management spectacle lens of claim 1, wherein the TFRIS is expressed as MTF and a threshold value of at least 0.025, 0.05, 0.075 or 0.1 is used to compare the TFRIS with the same optical element that is devoid of tilt and/or extrusion,

24. The myopia management spectacle lens of claim 1, wherein the peripheral treatment zone around the central zone is annular or oval or is divided into horizontal, vertical, temporal, nasal, superior, or inferior treatment zones.

25. The myopia management spectacle lens of claim 1, wherein the increase in width of TFRIS obtained with the tilted and/or extruded optical element is at least 0.1 mm greater than with the same optical element devoid of tilt and/or extrusion.

26. The myopia management spectacle lens of claim 1, wherein the tilt of the tilted and/or extruded optical element is further optimised to achieve a maximum width in TFRIS compared to an optical element devoid of tilt and/or extrusion, at each visual field angle.

27. The myopia management spectacle lens of claim 1, wherein each of the tilted optical elements is configured with a base, a geometrical centre and an apex, with the apex being located at a vertical distance or height from the base, and a horizontal distance or an amount of decentration with respect to the geometrical centre of the base, wherein the height and the amount of decentration of the apex with respect to the base defines a steepness and a tilt of each optical element, defined by tilt control parameter and tilt angle, and wherein the steepness and/or the tilt of each tilted optical element increases as a function of visual field angle; wherein the tilt control parameter of the titled optical element is between −1 and 1 mm; wherein the tilt angle control parameter of the geometrically titled optical element is between 1 to 30 degrees.

28. The myopia management spectacle lens of claim 1, wherein the axis of the connecting element is decentered and the magnitude of decentration is between −1 and 1 mm.
